(19) United States
(12) Patent Application Publication
(10) Pub. No.: US 2011/0166710 A1
(43) Pub. Date: Jul. 7, 2011

(54) METHODS AND SYSTEMS TO SIMULATE AND OPTIMIZE WHOLE BUILDING COMFORT AND ENERGY PERFORMANCE

(75) Inventors: Scott M. Kordik, West Dundee, IL (US); Randy S. Storch, Highland Park, IL (US); Joe Brian Doran, Round Rock, TX (US); Matthew Banach, Gurnee, IL (US); Bruce Alan Keller, Stillwater, MN (US)

(73) Assignee: The Wiremold Company, West Harford, CT (US)

(21) Appl. No.: 12/941,727

(22) Filed: Nov. 8, 2010

Related U.S. Application Data
(60) Provisional application No. 61/280,826, filed on Nov. 9, 2009.

(51) Int. Cl. G06F 1/32; G05D 23/00

(52) U.S. Cl. 700/277; 700/295; 700/291

(57) ABSTRACT

A method and system for balancing user comfort with energy conservation in an energy management system having a plurality of electrical devices includes a dial system in communication with the energy management system. Movement of a movable member of the dial system between the first extreme and the second extreme commands the energy management system to change the operating settings of the plurality of electrical devices. A method for optimizing energy conservation in a building having an energy management system with a plurality of electrical devices includes inputting and defining fixed and variable building parameters, as well as building usage conditions predicting building usage. The variable building parameters are varied to minimizing energy consumption by the energy management system in accordance with the fixed building parameters and the predicted building usage.

### CROSS-REFERENCE TO RELATED APPLICATIONS

This application claims priority to U.S. Provisional Patent Application Ser. No. 61/280,826, filed Nov. 9, 2009, which is hereby incorporated by reference in its entirety.

### TECHNICAL FIELD

The invention relates to concepts associated with energy management systems and, more particularly, to methods and systems for providing a customer/end user with means to facilitate adjustment of energy management systems settings (e.g., lights, plug loads, HVAC and the like) in a substantially simultaneous manner, and further, methods and systems for providing the customer/end user with recommendations on optimizing work space with respect to energy management.

### BACKGROUND INFORMATION

A significant amount of work is currently being performed in technologies associated with control of what can be characterized as “environmental” systems. Such systems may be utilized in commercial and industrial buildings, residential facilities, transportation systems and other environments. Control functions may vary from relatively conventional HVAC temperature control to extremely sophisticated systems for control of the entirety of a city's subway complex.

Development is also being undertaken in the field of network technologies for controlling environmental systems. References are often made in current literature to “smart” buildings or rooms having automated and centralized environmental functionality. This technology provides for networks controlling a number of separate and independent functions, including temperature, lighting and the like.

There are a number of issued patents directed to various aspects of control of environmental systems. For example, Callahan, U.S. Pat. No. 6,211,627 B1 issued Apr. 3, 2001 discloses lighting systems specifically directed to entertainment and architectural applications. The Callahan lighting systems include apparatus which provide for distribution of electrical power to a series of branch circuits, with the apparatus being reconfigurable so as to place the circuits in a dimmed or “not-dimmed” state, as well as a single or multi-phase state. Callahan further discloses the concept of encoding data in a form detectable in electrical load wiring and at the load. The data may include dimmer identification, assigned control channels, descriptive load information and remote control functionality. For certain functions, Callahan also discloses the use of a handheld decoder.

D'Aleo et al., U.S. Pat. No. 5,191,265 issued Mar. 2, 1993 disclose a wallmounted lighting control system. The system may include a master control module, slave modules and remote control units. The system is programmable and modular so that a number of different lighting zones may be accommodated. D'Aleo et al. also disclose system capability of communicating with a remote “power booster” for purposes of controlling heavy loads. Dushane et al., U.S. Pat. No. 6,196,467 B1 issued Mar. 6, 2001 disclose a wireless programmable thermostat mobile unit for controlling heating and cooling devices for separate occupation zones. Wireless transmission of program instructions is disclosed as occurring by sonic or IR communication.

Other patent references disclose various other concepts and apparatus associated with control systems in general, including use of handheld or other remote control devices. For example, Zook et al., U.S. Pat. No. 4,850,009 issued Jul. 18, 1989 disclose the use of a portable handheld terminal having optical barcode reader apparatus utilizing binary imaging sensing and an RF transceiver. Sheffer et al., U.S. Pat. No. 5,131,019 issued Jul. 14, 1992 disclose a system for interfacing an alarm reporting device with a cellular radio transceiver. Circuitry is provided for matching the format of the radio transceiver to that of the alarm reporting unit. Dolin, Jr. et al., U.S. Pat. No. 6,182,130 B1 issued Jan. 30, 2001 disclose specific apparatus and methods for communicating information in a network system. Network variables are employed for accomplishing the communication, and allow for standardized communication of data between programmable nodes. Connections are defined between nodes for facilitating communication, and for determining addressing information to allow for addressing of messages, including updates to values of network variables. Dolin, Jr. et al., U.S. Pat. No. 6,353,861 B1 issued Mar. 5, 2002 disclose apparatus and methods for a programming interface providing for events scheduling, variable declarations allowing for configuration of declaration parameters and handling of I/O objects.

Although a number of the foregoing references describe complex programming and hardware structures for various types of environmental control systems, it is desirable for certain functions associated with environmental control to be readily useable by the layperson. This is particularly true at a specific location, where it may be desirable to readily initially configure or reconfigure relationships or “correlation” between, for example, switching devices and lighting apparatus. Also, it may be desirable for such capability of initial configuration or reconfiguration to preferably occur within the proximity of the switching and lighting apparatus, rather than at a centralized or other remote location. In addition to the foregoing, particular attention is being directed to energy conservation. In this regard, reviews are currently being undertaken with respect to time periods and quantities of power which are used in various types of residential, commercial and industrial facilities. For example, it would be desirable to be able to determine target values for power consumption within a total facility, and be able to adjust energy transmissions based on an “as needed” basis, so as to maintain power consumption at a specific level, or otherwise within a specific tolerance window.

### SUMMARY OF THE INVENTION

An embodiment of the present invention relates to a method and system for balancing user comfort with energy conservation within a building having an energy management system. The energy management system includes a plurality of electrical devices and a controller in communication with the plurality of electrical devices. The controller controls operating settings of the plurality of electrical devices. A dial system is in communication with the energy management system and includes a movable member. Movement of the movable member commands the controller to change the operating settings of the plurality of electrical devices.

The system may change the operating settings of the plurality of electrical devices to reduce energy consumption when the movable member is moved toward an energy conservation extreme and may change the operating settings of the plurality of electrical devices to improve user comfort when the moveable member is moved toward a user comfort extreme.

Accordingly to an embodiment of the present invention, the plurality of electrical devices may include lights, plug loads, HVAC systems and the like. The operating settings of the plurality of electrical devices may include, on/off states, duration that the electrical device is powered, percents of power supplied to the electrical device, temperature set points and the like.

According to some embodiments of the present invention, the movable member may be a physical element such as a dial, a slide bar or the like. In yet other embodiments, the movable member may be a virtual member on a computer screen of the like.

According to some embodiments of the present invention, the operating settings of one electrical device of the plurality of electrical devices may change to compensate for a changed operating setting of another electrical device to maintain a current level of energy consumption when the position of the movable member unchanged.

Another embodiment of the present invention relates to a method for optimizing energy conservation in a building having an energy management system with a plurality of electrical devices. The method includes inputting and defining fixed and variable building parameters, as well as building usage conditions predicting building usage. The variable building parameters are varied to minimizing energy consumption by the energy management system in accordance with the fixed building parameters and the predicted building usage.

### BRIEF DESCRIPTION OF THE DRAWING

The present invention will be better understood from reading the following description of non-limiting embodiments, with reference to the attached drawings, wherein:

FIG. 1 illustrates an example embodiment of a prior art ions network, showing details in block diagram format of a lighting unit and a switch unit;

FIG. 2 is a block diagram partially in schematic format, illustrating a wand;

FIG. 3 is a block diagram showing an example embodiment of an energy management system in accordance with the invention;

FIG. 4 is a screen shot showing an example screen for indicating contents of a load zone, power utilized and the like;

FIG. 5 is a further screen shot showing an example of data stored and determined in real time for a particular dimmer;

FIG. 6 is a screen shot showing an example screen for adding a load shedding function;

FIG. 7 is a further screen shot directed to load shedding, showing an example screen for adding an additional load shedding goal;

FIG. 8 is another screen shot directed to the load shedding function, showing an example screen for editing load shedding trigger properties;

FIG. 9 is a block diagram showing an embodiment of the invention as implemented through the use of a data acquisition server system;

FIG. 10 is a block diagram showing various concepts of a singular energy management system in accordance with the invention, having a number of smart devices;

FIG. 11 shows details associated with a smart device having energy monitoring boards and a core board, along with connections to a gateway;

FIG. 12 is a block diagram showing various communications and functional relationships among energy management systems and a data acquisition server in accordance with the invention;

FIG. 13 is a block diagram illustrating a relay dimming module having an integrated energy monitoring function in accordance with the invention;

FIG. 14 is a block diagram of a communications hub having integrated energy monitoring of system usage in accordance with the invention;

FIG. 15 is a block diagram of a relay board having integrated energy monitoring in accordance with the invention;

FIG. 16 is a symbolic diagram showing a dial as a concept and tool for adjusting total energy comfort conservation versus total comfort;

FIG. 17 is a further symbolic diagram showing the use of a slide bar where adjustment of the slide bar will adjust between total energy conservation and total comfort;

FIG. 18 is a flow chart showing functional operation of the system using a gateway with the dial system and functional devices consuming energy;

FIG. 19 is a block diagram showing an energy management system, similar to FIG. 12, but showing the use of a dial system in accordance with the invention; and

FIG. 20 is a block diagram showing an advisor system according to an embodiment of the present invention.

### DETAILED DESCRIPTION OF THE INVENTION

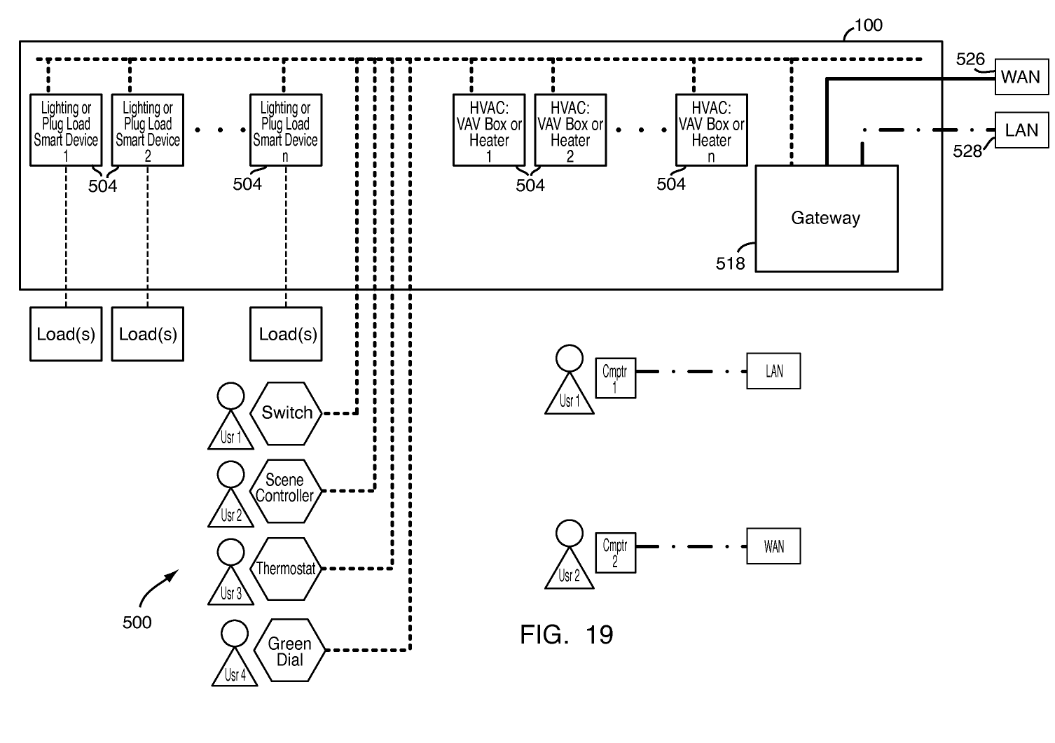

Referring to FIG. 19, the principles of an embodiment of the invention are disclosed, by way of example, in a dial system 500 adapted to communicate with an energy management system 100. The dial system 500 provides a user with means for facilitating simultaneous adjustment of operating settings of a plurality of electrical devices 504 within the energy management system 100, so as to allow adjustment of balance between energy conservation and comfort level.

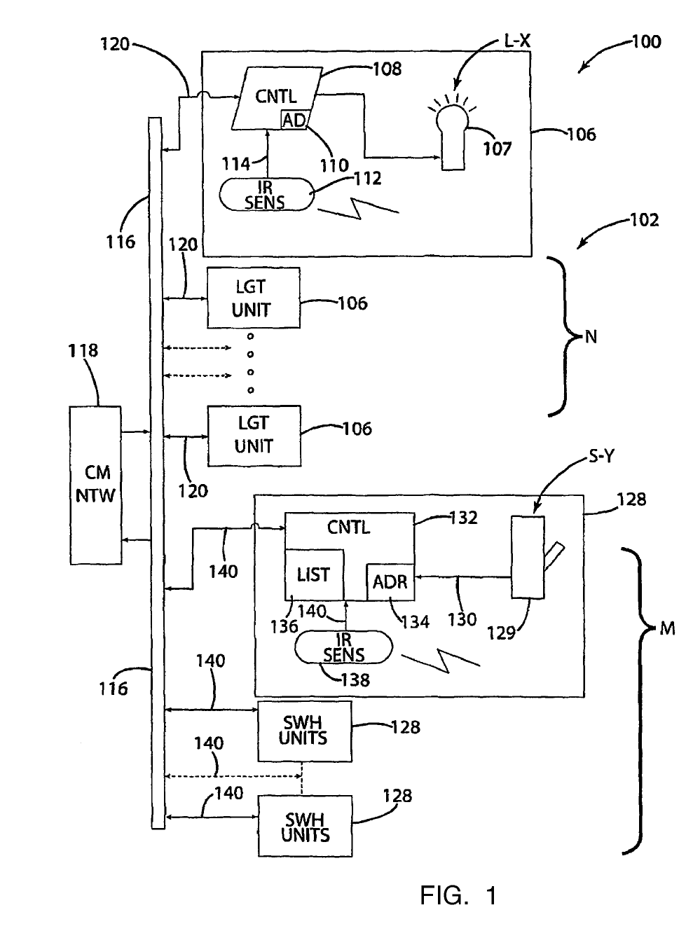

Referring to FIG. 1, energy management system 100 is shown adapted for use with a lighting system 102. This example energy management system is described in U.S. Pat. No. 7,277,930 issued Oct. 2, 2007, which is hereby incorporated by reference in its entirety. The present description discusses energy management system 100 in general, and then discusses the dial system 500 in connection with the energy management system 100.

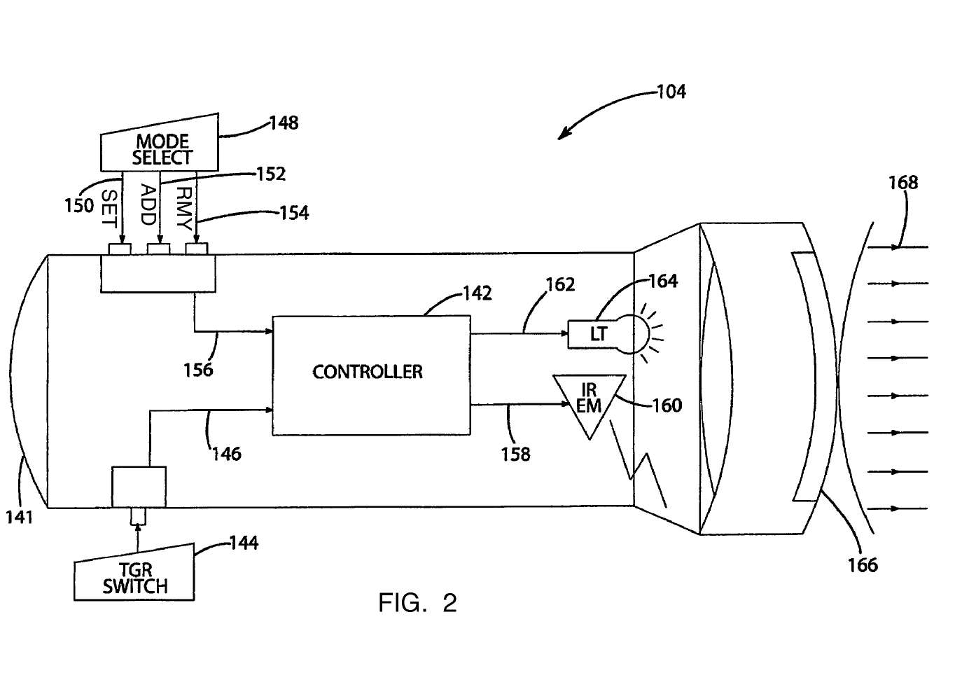

More specifically, referring to FIG. 2, the lighting system 102, shown in FIG. 1, is associated with one or more wands 104. The wand 104 is utilized with the lighting system 102, shown in FIG. 1, so as to initially configure or reconfigure relationships or correlations among switches and lights of the lighting system 102. That is, the wand 104 provides a manual, handheld means for determining which of the lights of the lighting system 102, shown in FIG. 1, are controlled by which of the switches of the lighting system 102. Control of the lighting system 102 in accordance with the invention is provided through the use of relatively inexpensive apparatus, which is readily usable by the layperson.

Turning back to FIG. 1, the lighting system 102 includes a plurality of lighting units 106. In the particular embodiment illustrated in FIG. 1, there are n individual lighting units 106. Each lighting unit 106 includes a conventional light 107. The light 107 may be any one of a number of conventional lights, including florescent and LED devices. In view of the capability of the use of various types of lighting devices, the entirety of the energy management system 100 may be one in which AC and/or DC devices are employed. Further, the lighting devices and other components associated with the energy management system 100 in accordance with the invention may employ high voltage and low voltage functionality. The light 107 is electrically interconnected to and controlled by a controller 108, with each of the controllers 108 associated with one of the lighting units 106. Each of the controllers 108 may be a conventional programmable controller. Each programmable controller 108 will have a unique address 110 identifiable through the communications network of the lighting system 102. Each of the lighting units 106 further includes an infrared (IR) sensor 112. The IR sensor 112 is conventional in nature and may be any one of numerous commercially available IR sensor devices. An IR sensor 112 is associated with each of the lighting units 106, and is utilized to receive IR signals from the wand 104 as described in subsequent paragraphs herein. Each of the IR sensors 112 is adapted to convert IR signals from the wand 104 to electrical signals, and apply the same to the corresponding controller 108 through line 114.

Referring again to each of the controllers 108, each controller has bi-directional communication with a control bus 116 or similar common interface used to provide for control and communication among various devices, such as the lighting units 106 and the switch units to be described in subsequent paragraphs herein. The control bus 116 or a similar communications interface is associated with a communications network 118. Communications network 118 may be sophisticated in design and provide for network control of a number of different devices associated with environmental systems, in addition to switch and lighting apparatus. For example, communications network 118 may be associated with network control of sound management, electrical supply (both AC and DC), HVAC and other environmental control systems. Alternatively, communications network 118 may be relatively simplistic in design and provide only a few functions associated solely with switches and lights. Each controller 108 associated with a lighting unit 106 communicates with the control bus 116 through a line 120. Each controller 108 may have the capability of not only storage of a unique address 110 associated with the corresponding light 107, but may also store other information, such as light state and the like. In addition to the lighting unit 106, the lighting system 102 may also include a plurality of switch units 128. Each of the switch units 128 is utilized to control one or more of the lighting units 106. In the particular embodiment illustrated in FIG. 1, the lighting system 102 includes a series of m switch units 128. Referring to the specific switch unit 128 illustrated partially in schematic format in FIG. 1, the switch unit 128 includes a conventional switch 129. A switch 129 is associated with each one of the switch units 128. Each switch 129 can be any one of a number of conventional and commercially available switches.

Each of the switches 129 converts manual activation or deactivation into an output state applied on line 130. The state of switch 129 on line 130 is applied as an input to a conventional controller 132. Controller 132 is preferably a conventional programmable controller of any of a series of commercially available types. Each of the controllers 132 may correspond in structure to the controllers 108 associated with the lighting units 106. As with each of the controllers 108 of the lighting units 106, the controllers 132 each have a unique address 134 associated therewith. Each controller 132 may also include various programmable instructions and memory storage which may comprise a light control list 136 stored in writeable memory.

Each of the switch units 128 also includes an IR sensor 138. Each of the IR sensors 138 may correspond in structure and function to the IR sensors 112 associated with each of the lighting units 106. That is, each of the IR sensors 138 is adapted to receive IR signals as inputs signals, and convert the same to corresponding electrical signals. The electrical signals are applied as input signals on line 140 to the corresponding controller 132. As will be described in subsequent paragraphs herein, the input IR signals to the IR sensor 138 will be received from the wand 104, and will be utilized to compile and modify the light control list 136.

As with each of the controllers 108 associated with the lighting units 106, the controllers 132 associated with the switch units 128 will have bi-directional communication through line 140 with the control bus 116 of the communications network 118. Each of the switch units 128 may be configured (in accordance with methods described in subsequent paragraphs herein) so as to control one or more of the lights 107 of the lighting units 106. The general programmable control as specifically associated with the switch units 128 and the lighting units 106 is relatively straightforward, in that each of the controllers 132 may include, as part of the light control list 136, identifications of each of the unique addresses 110 of the lighting units 106 associated with the lights 107 to be controlled.

For purposes of controlling correlation or configuration among the lighting units 106 and the switch units 128, the embodiment illustrated in the drawings and in accordance with the invention includes a wand 104 as shown in block diagram format in FIG. 2. The wand 104 may include any type of desired mechanical structure, preferably including a housing 141. Enclosed within or otherwise interconnected to the housing 141 is a conventional programmable controller 142. The programmable controller 142 may be any of a number of conventional and commercially available controllers, preferably sized and configured for convenience of use within a device such as the handheld wand 104. The wand 104 also preferably includes a trigger switch 144. The trigger switch 144 may be manually operated by the user so as to generate a state signal as an input on line 146 to the controller 142. The state signal on line 146 may be a responsive signal to activation of the trigger switch 144 so as to cause the controller 142 to perform particular functions desired by the user.

The wand 104 also includes a mode selector module 148. The mode selector module 148 may preferably comprise a selector switching module adapted for three separate and independent inputs from the user. More specifically, the mode selector module 148 may include a SET switch 150, ADD switch 152 and REMOVE switch 154. The mode selector module 148 is adapted so as to generate and apply a state signal on line 156 as an input signal to the controller 142. The state signal on line 156 will preferably be of a unique state, dependent upon selective activation by the user of any one of the switches 150, 152 or 154. As with other specific elements of the wand 104, the mode selector module 148 may be one of any number of commercially available three switch modules, providing unique state outputs.

In response to state signals from the mode selector module 148 on line 156, and the trigger switch 144 on line 146, the controller 142 is adapted to apply activation signals on line 158, as input activation signals to an IR emitter 160. The IR emitter 160 is conventional in design and structure and adapted to transmit IR signals in response to activation signals from line 158.

In addition to controlling transmission of IR signals from the IR emitter 160, the controller 142 is also adapted to selectively generate and apply activation signals on line 162. The activation signals on line 162 are applied as signals to a visible light 164. As with the IR emitter 160, the visible light 164 may be any of a number of appropriate and commercially available lights for the purposes contemplated for use of the wand 104 in accordance with the invention.

In addition to the foregoing, the wand 104 may also preferably include a lens 166 spaced forward of the visible light 164. The lens 166 is preferably a lens which is transparent to both visible and infrared light. The lens 166 is also preferably a collimating lens for purposes of focusing the visible light 164 into a series of parallel light paths (e.g. a collimated light beam 168). The foregoing describes the general structure of one embodiment of a switch/light energy management system 100 in accordance with the invention. The energy management system 100 may include the lighting system 102 and the wand 104. The operation of the energy management system 100 will now be described with reference to FIGS. 1 and 2.

As earlier stated, a principal concept of the invention is to provide a means for configuring (or reconfiguring) the communications network, so that certain of the switch units 128 control certain of the lighting units 106. For these purposes, a plurality of wands 104 may be utilized. For example, the wands 104 may be numbered W-1, W-2, W-3 . . . W-a, where a is the total number of wands 104. An individual wand 104 may be characterized as wand W-A, where A is the particular wand number 1 through a. As earlier described, each of the wands 104 may be utilized to initiate one of three commands, namely SET, ADD or REMOVE, through use of the mode selector module 148, and its switches 150, 152 and 154. More specifically, and as an example, the user may wish to initiate a SET command for purposes of associating one or more of the switches 129 with one or more of the lights 107. The user may first activate the SET switch 150. At the time the SET command is to be transmitted to an appropriate one of the lights 107 or switches 129, the trigger switch 144 is activated by the user. The controller 142 of the wand 104, in response to the SET command signal and the trigger switch signal, will generate appropriate electrical signals to the IR emitter 160. The IR emitter 160, in turn, will transmit IR signals representative of the SET command. These IR signals will be received as input signals by the respective IR sensor 112 or 138 associated with the lighting unit 106 or switch 128, respectively, to which the wand 104 is then currently pointed.

For purposes of describing available configuration sequences for control of the lighting units 106 through the switch units 128, it is advantageous to number the lights 107 and switches 129. As earlier stated, the embodiment illustrated in FIGS. 1 and 2 utilize n lights 107 and m switches 129. An individual light 107 may be characterized as light L-X, where X is an integer from 1 to n. Correspondingly, an individual switch 129 may be characterized as switch S-Y, where Y is an integer from 1 to m.

For operation in accordance with the invention, the lighting system 100 will also maintain memory of each particular command and command number for each of the wands 104. For purposes of description, each command may be referenced as C-N, where N is the sequential number of the command generated by a specific wand 104. For example, a command referenced herein as W-4, C-3 would reference the third command from the fourth wand 104. To fully identify a particular command, it may be designated as W-4, C-3, SET, meaning that IR signals are generated from the fourth wand 104, indicating that, in fact, the signals are from the fourth wand, they represent the third command from the fourth wand, and they are indicative of a SET command.

If the wand 104 is being “pointed” to, for example, light L-2 when the trigger switch 144 is activated, the complete “directional” command may be characterized as W-4, C-3, SET, L-2. Correspondingly, if the wand is pointed at S-4, for example, the directional command may be characterized as W-4, C-3, SET, S-4. To designate ADD and REMOVE commands, the “SET” designation would be replaced by the designation “ADD” or “REMOVE,” respectively.

A specific sequential process will now be described as an embodiment in accordance with the invention to relate or correlate control between a particular one of the switches 129 and the lights 107. Assume that the user wishes to configure the lighting system 100 such that switch S-6 is to control light L-4. Further assume that the sixth wand 104 is being utilized by the user, and the last command transmitted by wand W-6 was the fourteenth command (e.g. C-14). Let it be further assumed that command C-14 from wand W-6 was transmitted to one of the switches 129. The user would first configure the mode selector module 148 for wand W-6 so as to enable the SET switch 150. The wand W-6 is than pointed to the lighting unit 106 associated with light L-4. The directional configuration of the wand 104 is indicated by the collimated light beam 168. With this configuration, the user may activate the trigger switch 144 of wand W-6. To indicate transmittal of the command, the light 164 may preferably be “blinked” so as to indicate appropriate command transmittal. The command may be characterized as W-6, C-15, SET, L-4. The command is transmitted to light L-4 through transmittal of IR signals from the IR emitter 160 associated with wand W-6. These IR signals will be received by the IR sensor 112 associated with the lighting unit 106 for light L-4. IR signals received by the IR sensor 112 are converted to corresponding electrical signals applied to the corresponding controller 108 through line 114. These signals are then also available to the communications network 118.

Following transmittal of the SET command to light L-4, the user then “points” the wand W-6 to switch S-6 of the set of switches 129. When the wand W-6 has an appropriate directional configuration as indicated by the collimated light beam 168, the trigger switch 144 can again be activated, thereby transmitting IR signals through the IR emitter 160 to switch S-6, indicative of a SET command. This directional command can be characterized as W-6, C-16, SET, S-6. The IR signals transmitted by the IR emitter 160 will be received by the IR sensor 138 associated with the switch unit 128 for switch S-6 of the set of switches 129. IR signals received by the IR sensor 138 from wand W-6 are converted to electrical signals on line 140 and applied as input signals to the corresponding controller 132. Signals indicative of the command are also made available to the communications network 118.

When this particular command is received by switch unit 128 for switch S-6, program control via controllers 108, 132, and communications network 118 will have knowledge that the SET command sent to switch S-6 was the sixteenth command from wand W-6. Programmable processes are then undertaken to determine the particular command corresponding to the fifteenth command from wand W-6, i.e. W-6, C-15. Through the prior storage of data associated with the command W-6, C-15, a determination is made that this particular command was a SET command transmitted to light L-4. With this information, the communications network 118 is provided with sufficient data so as to configure the lighting system 100 such that switch S-6 is made to control light L-4. Following this determination with respect to command C-15 for wand W-6, a search is made for the fourteenth command (e.g. C-14) transmitted from W-6. If it is determined that command C-14 from wand W-6 was a command transmitted to one of the switches 129, and not to any one of the lights 107, this particular sequence for configuration of the lighting system is then complete. Upon completion, activation of switch S-6 is made to control light L-4.

The foregoing sequence is an example of where a single one of the switches 129 is made to control a single one of the lights 107. In accordance with the invention, the lighting system 100 may also be configured so as to have one of these switches 129 control two or more of the lights 107. To illustrate a configuration sequence for control of three of the lights 107 by a single one of the switches 129, an example similar to the foregoing example using commands from wand W-6 may be utilized. More specifically, it can be assumed that command C-12 from wand W-6 was a command directed to one of the switches 129. It can be further assumed that the user wishes to have switch S-6 control not only light L-4, but also lights L-7 and L-10. Using wand W-6, the user may than transmit a SET command to light L-10 as the thirteenth command from wand W-6. That is, the command will be described as W-6, C-13, SET, L-10. Directional pointing of the wand W-6 toward light L-10 would be in accordance with the prior description herein. After command C-13 is transmitted, a further SET command can be transmitted to L-7. This will be the fourteenth command from wand W-6, and would be indicated as W-6, C-14, SET, L-7. Following this command, the two SET commands C-15 and C-16 for light L-4 and switch S-6, respectively, can be transmitted as described in the prior example. Following the receipt of command C-16 by the switch unit 128 associated with switch S-6, the communications network 118 and the associated controllers 108, 132 would than be made to search for data indicative of command C-15 from wand W-6. Upon a determination that command C-15 was a SET command to light L-4, switch S-6 would be made to control light L-4.

A further search would than be made for command C-14 from wand W-6. Unlike the prior example, the lighting system 100 would make a determination that this particular command was a SET command to light L-7, rather than a command to a switch 129. With command C-14 being transmitted to light L-7, the communications network 118 would be configured so that switch S-6 would be made to control not only light L-4, but also light L-7. Thereafter, the lighting system 100 would be made to search for data indicative of command C-13 from wand W-6. Upon a determination that command C-13 was a SET command to light L-10, the switch S-6 would be further configured through the communications network 118 so as to control not only lights L-4 and L-7, but also light L-10. A search for data indicative of command C-12 from wand W-6 would then be undertaken by the communications network 118. Upon determining that this particular command was a command directed to one of the switches 129, the communications network 118 would determine that this particular sequential configuration is completed. Upon completion, the controller 132 of the switch unit 128 associated with switch S-6 will include a light control list 136 having data indicative of switch S-6 controlling lights L-4, L-7 and L-10. Program control through the appropriate controllers and the communications network 118 will than effect this configuration, so that switch S-6 will have control of all three of the designated lights.

The foregoing examples of sequential configuration in accordance with the invention have illustrated the setting of control of a single light 107 by a single switch 129, and the setting of control of three of the lights 107 by a single switch 129. In addition to these functions, the lighting system 100 in accordance with the invention can also operate so as to configure a “master/slave” relationship among two or more of the switches 129. As an example, it can be assumed that wand W-6 was utilized to transmit a series of commands C-12, C-13, C-14, C-15 and C-16 as described in the foregoing paragraphs. It may also be assumed that the commands were exactly as described in the foregoing paragraphs in that the commands C-13 through C-16 were made to cause switch S-6 to control lights L-10, L-7 and L-4. A seventeenth command may then be generated through the use of wand W-6, with the command being a SET command and the wand W-6 being pointed at switch S-8. This command would be designated as W-6, C-17, SET, S-8. This command will be transmitted in accordance with the procedures previously described herein with respect to other SET commands. Upon receipt of IR signals by the IR sensor 138 associated with the switch unit 128 for switch S-8, the controllers and communications network 118 would than be made to search for data indicative of command C-16 from wand W-6. The data indicative of command C-16 from wand W-6 would indicate that this particular command was a SET command to switch S-6. Accordingly, the command C-16, which was immediately prior to command C-17 from wand W-6, was a command directed to a switch, rather than a light. Upon a determination that this immediately prior command C-16 was directed to switch S-6, and a determination that command C-15 was directed to a light L-4, program control through the communications network 118 would configure the lighting system 100 so that switch S-8 will be configured by the communications network 118 as a “master” switch for control of lights L-10, L-7 and L-4, while switch S-6 is “slaved” to switch S-8.

The foregoing commands from one of the wands 104 have been described with respect to SET commands. As earlier described, the mode selector module 148 also includes an ADD switch 152 and a REMOVE switch 154. Functionality of the lighting system 100 for purposes of these particular functions is similar to the functionality for the SET commands. Accordingly, relatively simple configuration sequences will be described in the subsequent paragraphs with respect to examples of use of the ADD and REMOVE commands. Continuing with the example of use of wand W-6, and assuming that a SET command would be the eighteenth command C-18, the mode selector module 148 may be set by the user so as to enable the ADD switch 152. Assume that the user wishes to add light L-20 to the control list for switch S-10. The user would than point the wand W-6 to light L-20, and activate the trigger switch 144 so as to transmit command W-6, C-18, ADD, L-20. Following transmittal of this command, the user may than transmit a further ADD command by pointing the wand W-6 to switch S-10. The command transmitted would be characterized as W-6, C-19, ADD, S-10. Upon receipt of the ADD command for switch S-10, the controllers 108, 132 and the communications network 118 would than search for data indicative of command C-18 from W-6. Data would be found indicative of command C-18 being an ADD command transmitted to light L-20. Accordingly, the communications network 118 would be configured so as to ADD light L-20 to the list of lights 107 which are under control of switch S-10. A further search would than be made for data indicative of command C-17 from wand W-6. Upon obtaining data indicative of the fact that command C-17 was a SET command to switch S-6, the configuration sequence would than be considered complete. That is, light L-20 would be controlled by switch S-10. Use of the ADD command, instead of the SET command, will cause light L-20 to be added to the lights 107 then currently being controlled by switch S-10.

In accordance with the foregoing description, it is apparent that if command C-17 had been an ADD command associated with a particular light, then not only light L-20, but also the light associated with command C-17 would also be added to the list of lights 107 controlled by switch S-10.

In addition to the SET and ADD commands, the user may also employ a REMOVE command. The REMOVE mode may be selected by enabling the REMOVE switch 154 of the mode selector module 148 associated with the particular wand 104 to be used. Functionality of the REMOVE command is similar to the functionality associated with use of the SET and ADD commands. To illustrate use of the REMOVE command, it can be assumed that the user wishes to REMOVE control of light L-30 by switch S-25. Using wand W-6, the user may enable the REMOVE switch 154, point the wand W-6 to light L-30, and activate the trigger switch 144. This causes transmittal of the command W-6, C-20, REMOVE, L-30. Upon completion, the user may then point wand W-6 to switch S-25, and again transmit a REMOVE command. This command may be characterized as command W-6, C-21, REMOVE, S-25. Upon receipt of the signals indicative of command C-21, the switch unit 128 associated with switch S-25 would than cause the communications network 118 to search for data indicative of command C-20 from wand W-6. Upon retrieval of data indicating that command C-20 from wand W-6 was a REMOVE command transmitted to light L-30, the communications network 118 would be reconfigured so as to REMOVE light L-30 from control by switch S-25. A further search would than be made for data indicative of command C-19 from wand W-6. Upon obtaining data indicating that command C-19 was a command directed to switch S-10, the REMOVE process would be considered complete. Through this reconfiguration, light L-30 would no longer be controlled by switch S-25. It will be apparent from the description of the foregoing configuration processes that control of two or more of the lights 107 may be REMOVED from a particular one of the switches 129, through processes similar to the foregoing.

The foregoing describes particular embodiments of a lighting system 100 in accordance with the invention. It will be apparent that other embodiments in accordance with the invention may be utilized, without departing from the principal concepts of the invention. For example, it would also be possible to have an IR emitter associated with each of the lighting units 106, and an IR emitter associated with each of the switch units 128. Correspondingly, an IR sensor could then be employed within each of the wands 104. With this type of configuration, each of the wands 104 may be utilized to receive and to transmit IR signals. Correspondingly, each of the switch units 128 and lighting units 106 can also be enabled to transmit IR signals. As an example of commands which can be utilized with this type of configuration, a command could be generated from a wand 104 or a switch unit 128 requesting certain of the lights 107 to “broadcast” their individual addresses. For purposes of undertaking such activities by a switch unit 128, various commands other than merely SET, REMOVE and ADD commands could be transmitted from each of the wands 104. With the foregoing types of configurations, switch units 128 may be made to directly transmit commands to lighting units 106 through spatial signals.

Still further, sensors could be included within switch units 128 and the wands 104 so as to sense visible light itself. With this type of configuration, commands may be transmitted to the lighting units 106 so as to cause the lights 107 themselves to “blink” their own codes, such as their unique addresses. It is apparent that other variations of spatial signal transmission/reception may be utilized in accordance with the invention, without departing from the novel concepts thereof.

In addition to the foregoing, it is also possible in accordance with the invention to include additional features regarding “feedback” to each of the wands 104. That is, it may be worthwhile to include means for indicating successful reception and execution of a command. In this regard, for example, and as earlier described herein, the visible light 164 for each of the wands 104 may be made to “blink” when the trigger switch 144 is activated, indicating the transmission of a command. Other functionality may be included to provide feedback, such as each of the lights 107 which is the subject of a command from one of the wands 104 being made to “blink” or otherwise indicate successful reception or completion of a command. Still further, and as somewhat earlier described herein, it would also be feasible in accordance with the invention to cause a switch unit 128 and the communications network 118 to cause all of the lights 107 which are the subject of a series of commands to “blink” so as to further indicate successful reception and/or completion of a command sequence.

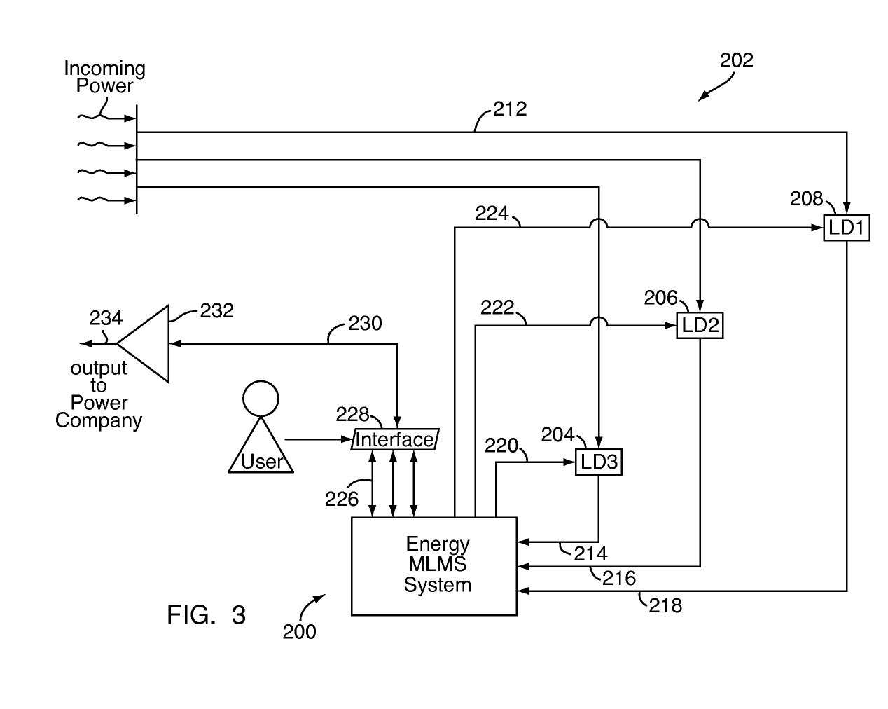

Turning now to the energy management system 100 in accordance with the invention, and with reference to FIG. 3, the drawing illustrates a facility 202 having an incoming power grid 210. Power is applied from the incoming power grid 210 on lines 212 to separate zone loads. In this case, the zone loads are defined as: zone load LED1 and 208; LED2 and 206; and LED3 and 204. Information regarding the various types of devices within the load zones (such as dimmers, switches, lights, computers and the like) is transmitted on lines 214, 216 and 218 to the energy management system 200. Within the energy management system 200, various data regarding the specific power consumptions, individual devices, average loads and other factual information can be measured and calculated. The devices within the load zones can be controlled (in terms of power consumption) through signals transmitted on lines 220, 222 and 224. Also, if desired, signals can be transmitted on a wireless basis or through a network such as the network previously described herein with respect to the light units 106 and the switch units 128.

Further, information regarding power consumption and other data can be received from the energy management system 200 and applied on lines 226 to an interface 228. The interface 228 can be a graphical user interface or the like through which interactive processes can be performed with the user. Further, the interface 228 can be used as a means for transmitting, on line 230 and external communications unit 232, output data to the power company on line 234. Still further, the lines 226 between the interface 228 and the energy management system 200 can be utilized to transmit information from the user and from the power company from the interface 228 to the energy management system 200. In this manner, power consumption, load targeting, load shedding and other such functions can be performed with the energy management system 200.

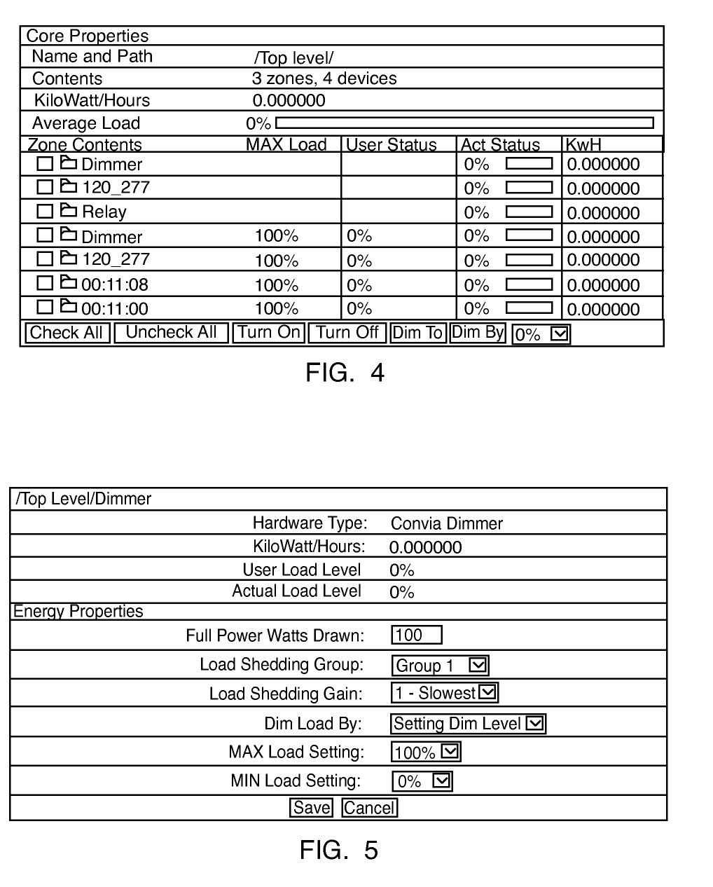

With respect to use, and with reference first to FIG. 4, the energy management system 200 can include, as previously described, a load shedding feature. The purpose of the feature is to enable an energy company or a facility management group to conserve energy usage over a period of time, without interfering with comfort and function of the space being used.

FIG. 4 shows a screen shot related to the load shedding feature and capable of being used so as to ensure that all energy consuming devices within the facility 202 has been discovered, labeled and placed under proper zone. In this regard, a control management feature can include a “settings/tools” section to appropriately identify and label the devices. As shown in FIG. 4, there is a section titled “zone properties” which shows the current path being viewed by the user, and the number of devices in the zone. Also shown are kilowatt/hours currently being consumed at this particular zone and its sub-zones, and the average load level.

The second section in FIG. 4 labeled “zone contents,” contains the table of the devices within the facility 202. The user can either click on a device to edit its energy properties or, alternatively, use check boxes next to the devices and zones (along with the buttons at the bottom of the page) to control the output level of these devices/zones.

Maximum load indicators in this table show the maximum load level to which the device is to be restricted. This value is controlled by the energy load shedding goal engine. The value can be edited, but the goal engine may possibly over right yet, depending upon particular selected options. “User status” shows the load level that the user will see. The “act status column” is the actual load level being output by the device. The “Kwh column” shows the current power the device is consuming.

FIG. 5 illustrates a screen shot showing functions that can be associated with particular devices, in this example, FIG. 5 relates to a dimmer. The second section of the screen shot relates to energy properties. The section entitled “full power watts drawn” can be used to calculate how much energy the device is consuming. Alternatively, in some embodiments, the devices may be able to measure their own actual energy consumption, thereby eliminating the need for the controller to calculate the amount of energy the device is consuming. The “load shedding group” identifies the group number used by the goal engine to determine in which order the device's load level should be modified by the load shedding goal engine. The “load shedding gain” is used to determine the size of the load level change implemented by the load shedding goal engine. The “dim load by” section allows the user to choose what criteria would be used by the load shedding goal engine for dimming the device. The “max load shedding” is set to determine the devices maximum load level. The “min load setting” section allows the user to set the device's lowest load level during a load shedding event.

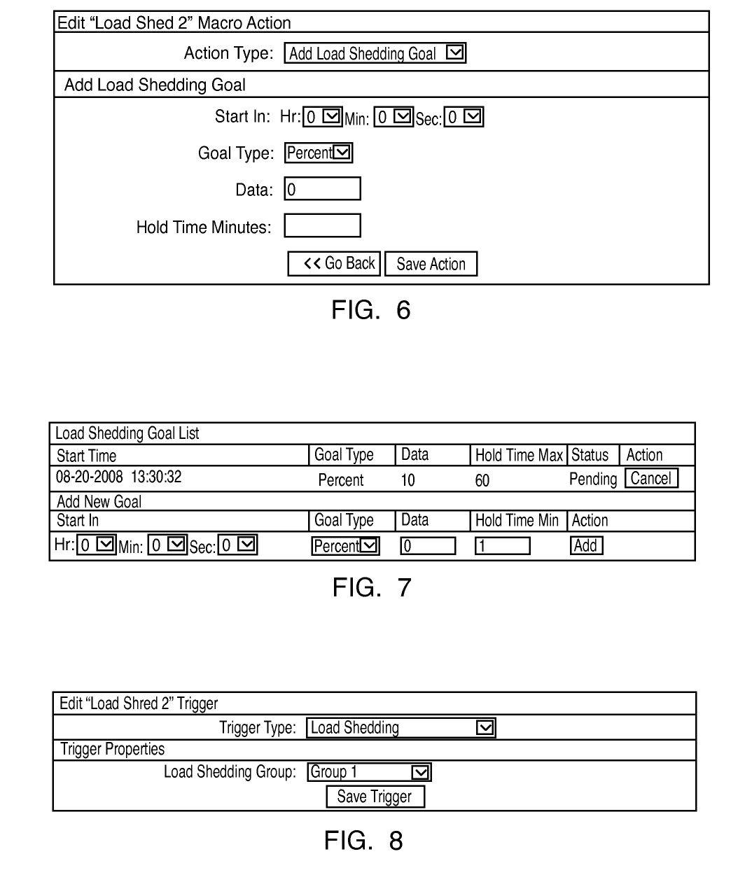

FIG. 6 illustrates a screen shot for adding a particular load shedding goal. FIG. 7 illustrates a screen shot showing that the user has the capability of viewing an entire list of the load shedding goals. FIG. 8 is a screen shot illustrating that the user has the capability of setting and editing the trigger properties for load shedding activities.

It should be noted that in accordance with various aspects of the invention, activities are capable of being undertaken which are broader than merely lowering the wattage which may be utilized by the entirety of a facility 202 when consumption exceeds certain targets. Instead, the invention contemplates the execution of various events that may have significant energy savings strategies. For example, in large office buildings, and when it is desired to lower power consumption, the invention may include the process of dimming all ambient light to a minimum or disenabling ambient light in total. Correspondingly, the energy management system 100 may monitor individual workstations, so as to determine those workstations that are currently occupied. For example, the energy management system 100 may monitor the status of occupancy sensors to detect whether or not workstations are occupied. The management system 200 can then enable or otherwise activate task lights only within those workstations which are then currently occupied. By monitoring the occupancy sensors, it can be determined which workstations subsequently become occupied or emptied.

It should also be emphasized that the energy management system 200 may be considered to be an energy management tool capable of being used by various entities. Such an entity management tool may be utilized, for example, by an owner of a building, although the owner is completely remote from the building. In addition, the management tool may be utilized by the power companies themselves.

It should also be noted that the load shedding or load balancing functions may involve setting a specific target for consumption, and then periodically measuring for the same. As earlier stated, various activities can be undertaken so as to lower energy consumption in the event that power consumption exceeds the target, either based on the entirety of a facility, individual zones or the like. It should also be emphasized that rather than use a specific target, the energy management system 200 could also utilize “windows” or tolerance bands. That is, rather than any specific target, the management system will operate so as to attempt to maintain power consumption within a particular range.

In addition to the foregoing, it is also contemplated that the energy management system could be remote from the facility 202, and could also be utilized to manage various other facilities. In this regard, communication could occur through the internet from the individual separate facilities to a common server. The server would essentially act as the energy management system 200 for each of the facilities 202.

Another description of energy management systems in accordance with the invention can include the concept of a global “controller” which would be responsible for either calculating each device's energy consumption data or gathering each device's measured energy consumption data. The data would be passed on to a web server. The controller would then send the calculated or measured energy information consumed for each device, along with meta data such as zone type, zone size, building hierarchy information and any naming or grouping parameters, to the web server for storage.

The foregoing activities could involve, for example, the following functions in accordance with the invention:
1. The gateway controller would need to register with the server, so as to keep data separate.
2. The controller would transmit information regarding the hierarchy structure to the server. If the user would remove a load zone from the hierarchy, then the data in the server could be disabled.
3. The gateway can also send all of the nodes that are reporting load level changes on a line by line basis. This information can be put into a device table in the database for later usage by the reporting tool.
4. The controller can then transmit all of the device energy usage information, on a periodic basis. The server would maintain an energy table that receives updates with the data. The server uses an engine which would continuously execute by using a “current energy table” so as to generate a log of energy.
5. For usage, a user would need to register for the service. The user would connect its web browser to the server, for purposes of syncing up. Once linked, the user can login to the server, and view information. Information can be shown in various methods, including tables, bar graphs and the like.
6. Locations can be identified by the user, with the user being able to receive information such as total energy, energy by zone, energy by device type and the like. In addition, a “comparison” option can be provided, which allows the user to select a guideline for purposes of “rationalizing” the data: day; week; month; priority group; and the like.
7. A home page or “dash board” can provide the user with the ability to “run a report.”

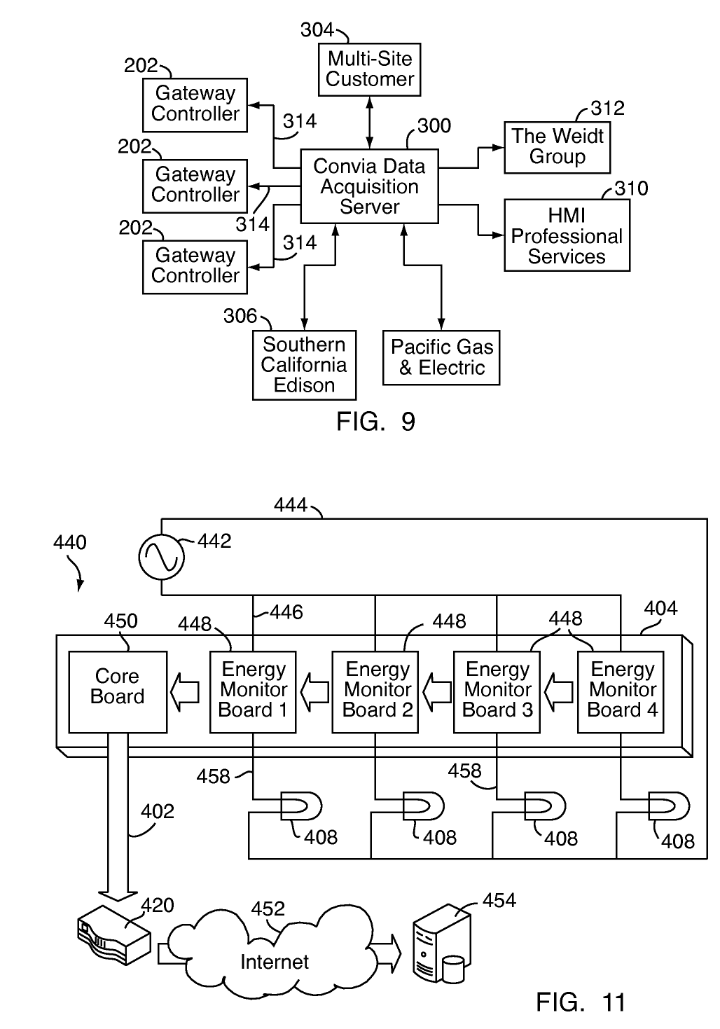

An energy management system in accordance with the invention can also be characterized with the use of a data acquisition server as shown in FIG. 9. With reference thereto, the system includes a series of gateway controllers 302 which can log data elements (including energy consumption data) from various facilities, such as the facilities 202 previously referenced herein. The controllers 302 have bidirectional communication on lines 314 with the data acquisition server 300. The data acquisition server 300 is used to aggregate data from the multiple and remote gateway system installations, for purposes of post processing and report of analytics. The data acquisition server 300 can also be utilized as a portal for managing multi-site installations, such as the multi-customer 304 shown in FIG. 9. The server 300 can also be utilized to broker energy reduction “demand response” exchanges from region utility companies, such as Southern California Edison 306 and Pacific Gas & Electric 308 also shown in FIG. 9. An implementation of the data acquisition server 300 in accordance with the invention would be capable, in its entirety, of controlling and interoperating with functions such as the following: lighting systems; plug loads; HVAC systems; audiovisual systems; and access control systems.

Correspondingly, the server 300 can also be utilized for purposes of receiving data related to the following: energy usage-lighting systems; energy usage-plug loads; energy usage-HVAC; alternative energy source and usage; subsystem usage; occupancy; system warranty activation; system configurations; site locations specific data (room square footage); and RTLS data.

Also in accordance with certain concepts of the invention, the data acquisition server 300 and the associated system may be utilized for what could be characterized as a “smart building viewer and report generator.” This particular application would request data acquisition server associated devices, and the user is able to view the energy usage, occupancy and other analytics for the system. In addition, the user would be capable of generating reports and implementing energy consumption and system usage changes.

Still further, third party consultants such as consultant 312 and professional services consultant 310 shown in FIG. 9 would be capable of remotely accessing the data acquisition software 300, for purposes of retrieving data.

Still further, the system may allow for the brokering of demand response commands between the remote systems and regional utility companies. These functions can include the following: denomination and selection of loads for curtailment and scheduling; automated curtailment notification; meter verifications; and settlement calculations. In addition, the system can also report and verify the activity utility, the customer's adherence to the demand response request.

Still further, with respect to multi-site management, the customer 304 can manage and control each of its facilities remotely through a web interface. This web interface also allows the company to review performance data of each site, and also create reports that compare the performance of individual sites to standard bench marks, as well as to each other.

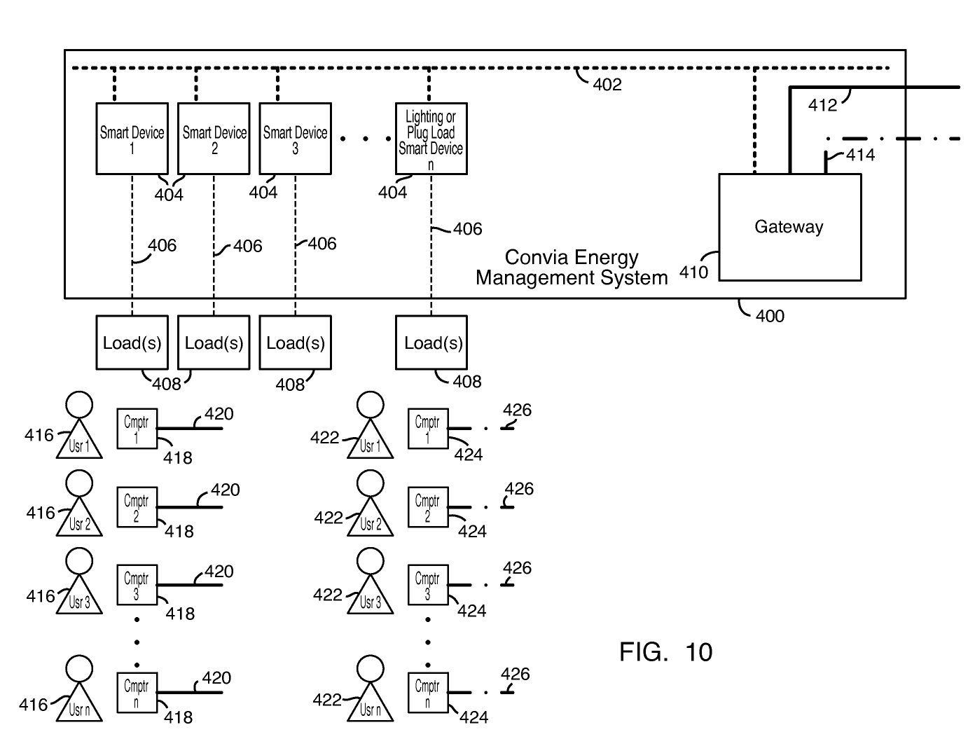

Additional concepts associated with energy management systems in accordance with the invention will now be described with respect to FIGS. 10-15. Turning to the drawings, FIG. 10 a block diagram illustrating an energy management system 400 in accordance with certain aspects of the invention, along with various other devices which are controlled by the energy management system 400. With reference to the system 400, the system 400 includes a network system communication bus 402. Shown symbolically in FIG. 10, the network system communication bus 402 can consist of three communication lines/buses. These buses can include a network bus, node bus and accessory bus. In an example embodiment, the network bus can consist of RJ11 patch cords which can carry protocol messages between hubs associated with the energy management system. The node bus can include RJ45 patch cords which carry protocol messages from the hubs to a series of smart devices 404, also shown in FIG. 10 as being part of the energy management system 400. The accessory bus can consist of RJ45 patch cords which carry the protocol messages from the smart devices 404 on the node bus to other smart devices 404. For a physically realizable system, the system must consist of at least one hub, two smart devices and the necessary patch cords for interconnecting the aforementioned components. The smart devices 404 can comprise a number of devices, as desired by the user. Smart devices have been disclosed in various other documents, including International Patent Application Publication No. WO2006/026648, published Mar. 9, 2006. The publication is entitled DESIGNATION BASED PROTOCOL SYSTEMS FOR RECONFIGURING CONTROL RELATIONSHIPS AMONG DEVICES. Components corresponding to the smart devices are disclosed in substantial detail in the aforementioned publication. As an example, each of the smart devices 404 can include a microprocessor, with a circuit board inside of the device. Upon power enablement, the microprocessor can load a program which can be stored in flash memory and initiate executing instructions. Each of the smart devices 404 can have one or more network bus ports connected to the circuit board. Also, certain of the smart devices can also have one or more accessory bus ports connected to a circuit board. In FIG. 10, each of the smart devices 404 is connected through lines 406 to a series of loads 408. The loads 408 can be various types of electrical loads. As an example, and with respect to a load which can be controlled, each of the loads can be in a form of a dimmable light. Each of the smart devices 404 can include the ability to turn loads 408 on and off. Also, in the case of dimming smart devices 404 connected to dimmable light fixtures as the loads 408, the ability can be provided to increase or decrease the brightness of the lights, thereby resulting in an increase or decrease of energy consumption.

As further shown in FIG. 10, a gateway 410 is provided. One or more gateways 410 may be included within a customer installation. Each gateway 410 can be in the form of a smart device 404 which actually constitutes a web server. The gateway 410 can include a node bus port, along with two TCP/IP network ports. One of the ports can be utilized to service a local area network (“LAN”), while the other can be utilized to service a wide area network (“WAN”), such as an office intranet. The line 412 can be characterized as a LAN communications line and port, which is essentially hosted by the gateway 410. Correspondingly, the line 414 illustrated in FIG. 10 can be characterized as a communications line and port for the WAN network, again hosted by the gateway 410. The gateway 410 can include software for executing an application which will provide a user with the ability to interact with the network system. More specifically, the user can access the software application through the use of a web browser on a computer which can be connected to either the WAN network or the LAN network. This is illustrated by the components in FIG. 10 which indicate LAN users 416 and WAN users 422. The LAN users 416 can utilize computers 418 which are connected through LAN communication lines 420 to the gateway 410. Accordingly, the representative lines 420 can essentially correspond to the representative lines 412. Correspondingly, the WAN users are shown as WAN users 422, which utilize computers 424. Each of the computers 424 can be connected through WAN communication lines 426 to the gateway 410. Accordingly, the WAN communication lines 426 correspond to the WAN communication lines 414. The software application associated with the gateway 410 can include features such as organizing and naming the devices 404 on the system, as well as creating “custom” events which may be in the form of a series of network actions. These actions can include the control of energy to the loads 408 based on time, date, weather or other system messages which may be in the form of various other types of triggers.

FIG. 11 illustrates other aspects of the energy management system 400 in accordance with the invention, and is particularly directed to concepts associated with energy monitor boards and the core boards, along with their functions and communication paths to other components of the energy management system 400. More specifically, FIG. 11 illustrates an energy data path 440 in representative form, with the path including an AC or other type of power source 442. The power source 442 provides power along power lines 444 to loads 408, previously described with respect to FIG. 10. FIG. 11 further illustrates a smart device 404, and shows specific components associated with the same. In the smart device 404 shown in FIG. 11, there are a series of four energy monitor boards 448. Power from the power source 442 is directed through the energy monitor boards 446 to the individual loads 408. Correspondingly, each of the energy monitor boards 448 includes a communications path 456 to a core board 450. The core board 450 is connected through the system communications bus 402 to the gateway 410. From the gateway 410, communication signals can be applied over an internet path 452 to a data acquisition server (“DAS”) 454, which will be described in greater detail in subsequent paragraphs herein. The number of energy monitor boards 448 which may be associated with one smart device 404 is variable. Each of the energy monitor boards 448 can be characterized as a circuit board which includes a programmed microprocessor and a computer chip. Upon power enablement, the microprocessor can load its program from flash memory and initiate instructions. The program can cause the microprocessor to communicate with the computer chip. Among another data, the computer chip can measure, in real time, the active energy of the connected load 408. This is through the connections from the energy monitor boards 448 on paths 458 to the loads 408.

In an example embodiment, the core board 450 can be characterized as a master circuit board within the smart device 404. Each of the devices 404 will have at least one master circuit board 448 and one core board 450. The software associated with the core board 450 can collect data (for example, in the form of watt hours every minute) from the energy monitor boards 448. The core board 450 can then forward the data onto the network where the gateway 410 can receive, process and store the data. In the example embodiment, for each smart device 404 having a core board 450 and at least one energy monitor board 448, the gateway 410 can accumulate each of one-minute active energy readings for a period of 15 minutes. After the fifteenth reading, the gateway can transmit the accumulated active energy (for each device 404) to what could be characterized as an energy server. The energy server corresponds to the data acquisition server (“DAS”) shown as data acquisition server 454 in FIG. 11. The energy server 454 can store the 15 minute readings from each device 404 connected to a particular gateway 410 within a database. As an example, the data could be stored for a period of time of up to five years, dependent upon the particular service the customer is receiving.

With respect to additional details of a specific embodiment, the gateway 410 can receive the energy data each minute and save the data for each device 404. The gateway 410 can store the summed data into a file Metrix data every 15 minutes for purposes of sending to the data acquisition server 454. The gateway 410 can transmit the Metrix data file to the data acquisition server 454 every 15 minutes, from the time that the gateway is enabled. In one embodiment, the gateway 410 can “open” a TCP/IP port over the internet (shown as path 452) and transmit the meta data file. If the file was successfully sent, the file on the gateway 410 can be deleted.

The Metrix file can be in a format which has a line for each energy reporting device, for each 15 minutes of the day. The data can, as an example, be dot delimited. In such a configuration, and again as an example embodiment, the first part of the data can be a file version number, with the second data segment being the serial number of the gateway 410. A third segment of the data can be an identification for the device 404 from which the energy data was transmitted. The fourth segment of the data can define the type of data which is being provided (i.e. energy). The fifth segment can be the energy data itself, and the sixth segment can be a UTC time stamp.

Although this exemplary embodiment has been described in connection with specific time periods for the purpose of illustration, it should be understood by those skilled in the art that the various time periods may differ in other applications of the system and should be selected based upon the desired performance and application needs.

With respect to the smart devices 404, it was previously stated that such devices could be in the form of dimmable relays for purposes of controlling an increase or decrease in light intensity for loads in the form of dimming lights. It should also be emphasized that the smart devices 404 can be non-dimming (i.e., on-off only) and thus utilized for various other types of energy loads such as plug loads for powering task lights, fans, computers, etc. There are other smart devices in the system that do not directly control energy loads but instead provide the user with a feedback mechanism to the system on how the load controlling smart devices should behave. These smart devices can include switches, scene controllers, occupancy sensors and the like.

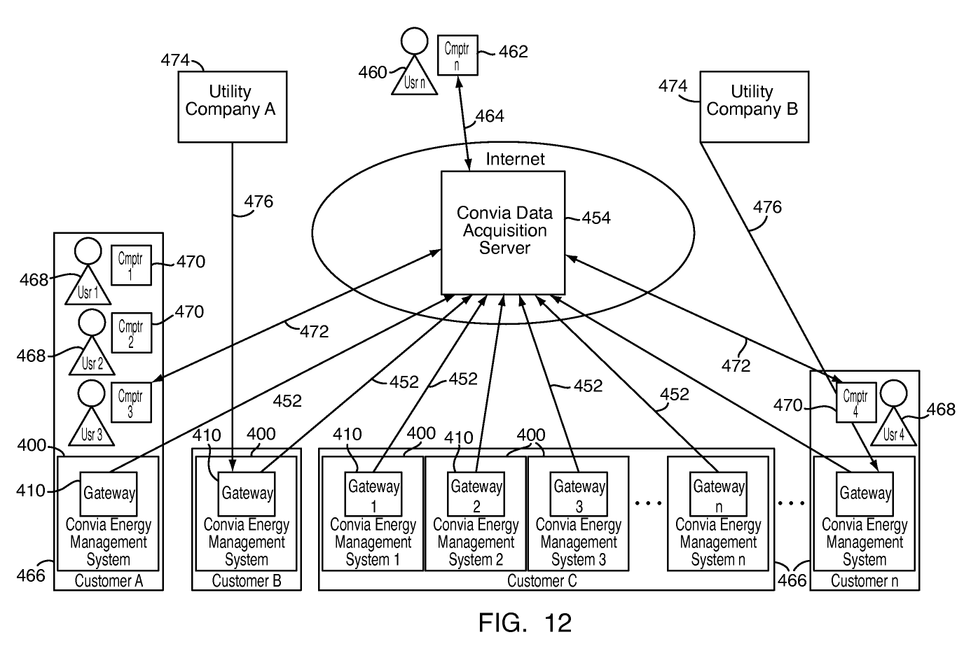

Additional details regarding the energy management system 400 in accordance with the invention and its use with the data acquisition server 454 are illustrated in FIG. 12. As shown therein, the data acquisition server 454 can be in the form of a web server which essentially “sits out” on the internet, and maintains the database of energy and occupancy data from all customers with installed energy management systems 400. As partially illustrated in FIG. 11, FIG. 12 illustrates the concept of a series of energy management systems 400 having gateways 410, which transmit data to the data acquisition server 454 over internet paths 452. The data acquisition server 454 can be characterized as hosting or executing software applications that can be accessed and interact with users or customers, through the use of a computer with an internet connection. Such a user is shown as user 460 having a computer 462 which communicates with the data acquisition server 454 through internet path 464.

FIG. 12 also illustrates a series of customers 466, which are individually identified as customers A, B, C . . . n. Each of the customers 466 is a customer having an installed energy management system 400 with one or more gateways 410. For example, customer C is illustrated as having multiple energy management systems 400. It should be noted that each of the energy management systems 400 may be installed in one or more customer sites, with each system 400 having at least one gateway 410.

FIG. 12 also illustrates a series of users 468, each with a computer 470. The computers 470 can interact with the data acquisition server 454 through internet paths 472. In a particular embodiment, the users do not necessarily need to be at a customer's site for purposes of accessing or interacting with the data acquisition server 454. Instead, users can be located at a remote site, so long as they have access to computer 470 having an internet path connection 472. FIG. 12 also illustrates communication capability with utility companies, identified as utility companies 474, consisting of utility company A and utility company B. The utility companies 474 are shown as having communication paths 476 which connect to selected gateways 410 of various customers. With one embodiment, the interaction provided by the communication paths 476 can be in the form of requests for changes to the customer's energy consumptions. A request of such a nature to the gateways 410 can trigger load shedding and load balancing events to occur within the energy management systems 400.

It should also be noted that another embodiment can include an alternative version where server software applications are provided directly to customers, so as to allow the customers to host on a server located on the customer's premises. Such an embodiment could be utilized in situations of relatively high security, where the customer does not wish to have internet connections to the customer's facilities and potential access to customer intranet.

General concepts associated with the embodiments of energy management systems in accordance with the invention as illustrated in FIGS. 10, 11 and 12 will now be described. In an example embodiment, the data acquisition server 454 can store 15 minute readings from each device 404 connected to a particular customer gateway 410 within a data base. When a customer wishes to view the energy consumption of various devices, rooms, zones, floors or buildings, the customer can log into a website with a security identification and password, provided by the website owner. The customer may then not only view energy consumption for their lighting, plug loads, HVAC, etc., but also are able to compare consumption to any particular standard selected by the customer. Such a standard could be a standard typically referred to as an ASHRAE (American Society of Heating, Refrigerating and Air Conditioning Engineers) standard. The customer also has the ability to define their own standards. Still further, the customer could run reports from the website which would allow the customer to compare energy consumption and occupancy information across different rooms, zones, floors and buildings.

Various concepts associated with load shedding and dynamic load balancing will now be described. Load shedding can be characterized as an event which occurs when a new, lower total energy consumption level is set, and the energy management system 400, in response, will begin to “trim” the energy consumption of the loads 408 connected to the devices 404 to achieve the desired consumption levels. A new energy consumption level (which can be characterized as a goal or target) can be set in various ways. As an example, scheduled events can be created by the customer within a corresponding gateway 410. Also, an immediate request by the customer can be provider through the gateway 410. In addition, an immediate request by the customer's energy provided (or utility company) can be set, based on a chosen standard (such as ASHRAE) for which the customer wishes to maintain adherence. The length of time that the new energy level is held can be specified by the party which sets or initiates the load shedding event.

Decrease in the energy consumption within the energy management systems 400 can occur in several ways. For example, and in accordance with one embodiment of the invention, the smart devices 404 which have dimming capabilities (and are connected to dimmable light fixtures) can decrease energy consumed by their loads 408 dimming the light fixtures. For example, if a dimmable device 404 is instructed to decrease the corresponding load energy usage by 10%, the device 404 can dim the light fixture until it detects that it has achieved the new energy level. Within the smart device, the process can include the core board 450 receiving a load shedding message which pertains to a priority group of which it is a member. The message can be in the form of the energy goal for that particular priority group, and it can be passed from the core board 450 to the energy monitor boards 448. The energy monitor boards 448 can speed up their energy readings from, for example, one minute to two seconds, but still report the one minute active energy information up to the core board 450 for the gateway 410 to accumulate, and to then send to the data acquisition server 454. The energy monitor board 448 can request that the core board 450 increase or decrease its dimming output so as to achieve the energy goal. When the energy monitor board 448 detects that the energy goal has been reached, transmissions can occur so as to inform the core board 450 that the board 450 can inform the gateway 410 of the fact that the target has been reached, and the new dimming level. The energy monitor boards 448 can then remain in this operating mode, until the gateway 410 sends messages over the network informing all devices that the load shedding period has ended. The core board 450 can then return the dimming level of the light fixture back to its original state, and the energy monitor board 448 can go back to taking energy readings on a per minute basis. As a further example, if the device 404 has its light fixture load 408 at 90% brightness, and then during load shedding the device 404 will dim its light fixtures to 65% brightness, the device will bring the light fixture back up to 90% brightness when the load shedding event has ended.

Devices 404 which are associated with loads 408 which do not have dimming capabilities can only increase or decrease energy consumption by the loads 408 by turning internal relays on or off. If the devices 404 are included within a priority group which is involved in the load shedding, they will enable or disable the loads 408 depending upon the direction desired for energy consumption increase or decrease. When the load shedding event ends, the device 404 will return the load 408 to the previous state.

Dynamic balancing occurs when, during a load shedding event, other lights or other devices are turned on (bringing the energy level back up over the new energy target level). In response, the energy management system can restart the process of trimming energy consumption (dimming lights and/or turning off lights and other devices) to return back to the target energy level. Correspondingly, if energy is removed from the system during a load shedding event (bringing the energy level below the target energy level), the system can respond by adding energy consumption (i.e. brightening lights and/or enabling lights and other devices). Accordingly, once an energy level target is set, the energy management systems 400 in accordance with the invention will increase and decrease energy consumption, so as to stay as close as possible to the target.

Load shedding and dynamic load balancing can be characterized as being accomplished through a series of messages passed through the gateways 410 and the various devices 404 within the system. As previously described, in one embodiment, each device 404 can send a message over the network each minute, identifying the active energy consumption for the past minute. Accordingly, the gateways 410 “know” the current energy consumption of each of the loads 408 connected to the devices 404 within the system. When a load shedding event is executed, the gateways 410 can transmit messages to one or more priority groups, informing the groups that they need to either increase or decrease their energy consumption by a specific amount of watt hours or percent of watt-hours so as to achieve the chosen energy target.

In one embodiment of the invention, the load shedding and dynamic load balancing require that the devices 404 be associated with a priority group. A priority group can be characterized as a number assigned to one or more devices 404. During load shedding and dynamic load balancing, the gateways 410 can transmit messages to the priority groups so as to adjust energy consumption levels. Priority group one can be characterized as the first group to receive load change requests, relating to increase or decrease of energy consumption during load shedding and dynamic load balancing. If the change of energy consumption level in priority group one does not sufficiently affect the system's total energy consumption sufficiently so as to meet the energy level target, then the gateways 410 can send load change request messages to priority group two. This process can continue until energy level targets are achieved. The devices 404 can handle a plurality of priority groups. However, in accordance with certain aspects of the invention, the devices 404 do not need to be assigned to a particular priority group. However, if a device 404 is not assigned to a priority group, then it is assumed that the device is not to partake in load shedding events. As a result, the device 404 will not change its load level during load shedding and dynamic balancing. This is useful to a customer if there are critical light fixtures or other loads that need to be maintained in a particular state at all times.

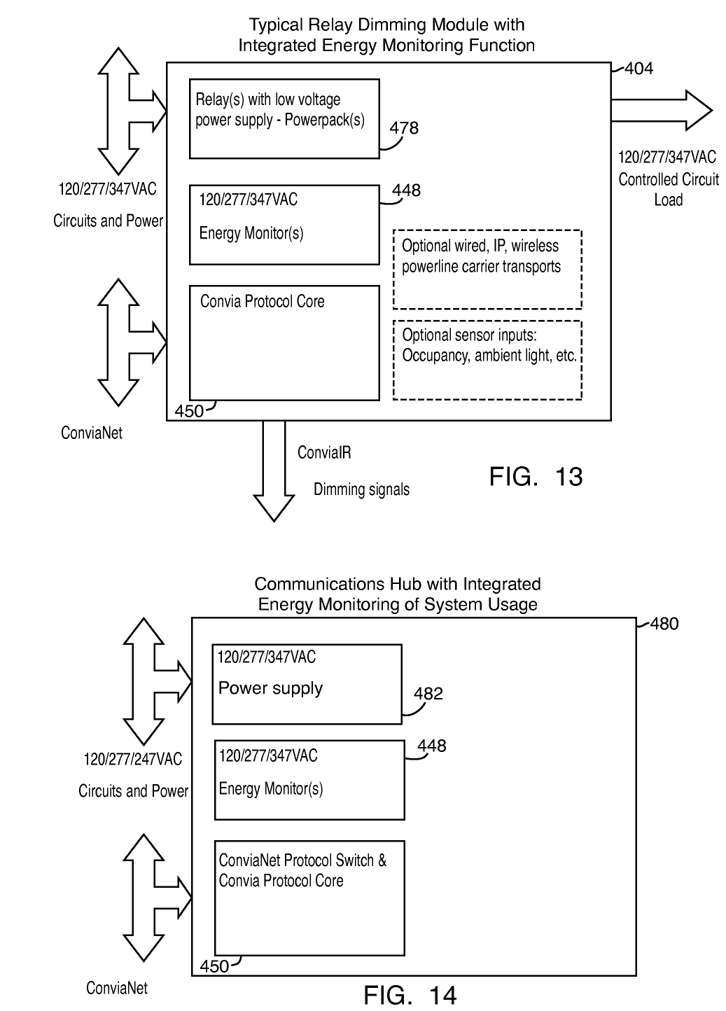

For purposes of further understanding of example embodiments of the invention, FIG. 13 illustrates a relay dimming module 404 having integrated energy monitoring functions in accordance with the invention. As shown in FIG. 13, relays are provided with low voltage power supplies. Energy monitor boards 448 and a core board 450 are also provided. Communications can be provided optionally through a wire, IP, wireless or power line carrier transports. Optional sensor inputs can include occupancy, ambient light and various other inputs. Control circuit loads can be at various voltages. The relay dimming module 404 can be utilized for distributed zone control with energy monitoring. Multiple relays 478 and energy monitors 448 can be utilized. The module 404 can control and monitor lighting loads as well as plug loads and other miscellaneous loads in a commercial workspace environment. Currently, the approach that is often used in the market place is for energy monitoring at a circuit panel. Systems in accordance with certain aspects of the invention are unique in that zone level control and usage/monitoring are coupled together, so as to achieve improved energy optimization in a commercial building space.

FIG. 14 illustrates a communications hub 480 having integrated energy monitoring of system usage. The hub 480 includes power supply 482, at least one energy monitor 448 and one core board 450. The switch in the form of the communications hub 480 can incorporate energy monitoring so as to provide real time energy usage of control systems accessory devices power usage. Known control systems calculate their consumptions based on estimates. In accordance with certain aspects of the invention, the systems in accordance with the invention will accurately show energy usage of not only commercial work spaces, but also the control systems themselves.

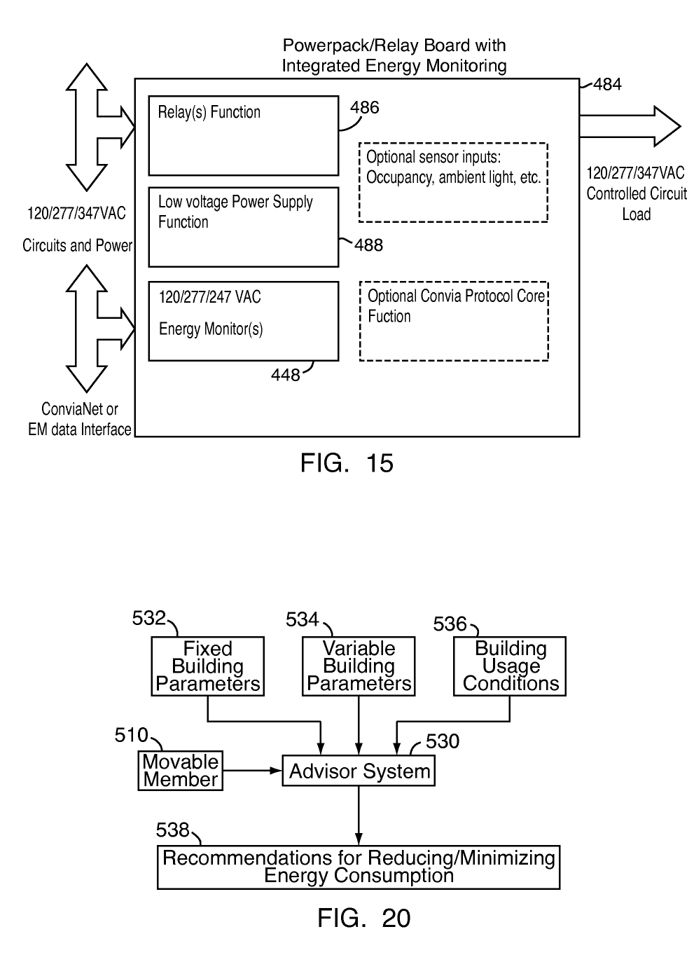

FIG. 15 illustrates a relay board 484, having integrated energy monitoring. The board includes relay functions 486, low voltage power supply functions 488, and energy monitor boards 448. Optional sensor inputs include occupancy, ambient light and the like. There can also be an optional function associated with a core board 450. By integrating high voltage relay functions of common sensor packs with energy monitoring and protocol/signal interfacing, an ability is provided to readily upgrade existing control installations which use sensor power packs. This upgrade will provide for energy monitoring and data logging by means of control systems in accordance with the invention. Multiple relay energy monitoring boards 448 can be designed so as to refine and optimize the relay dimmer modules.

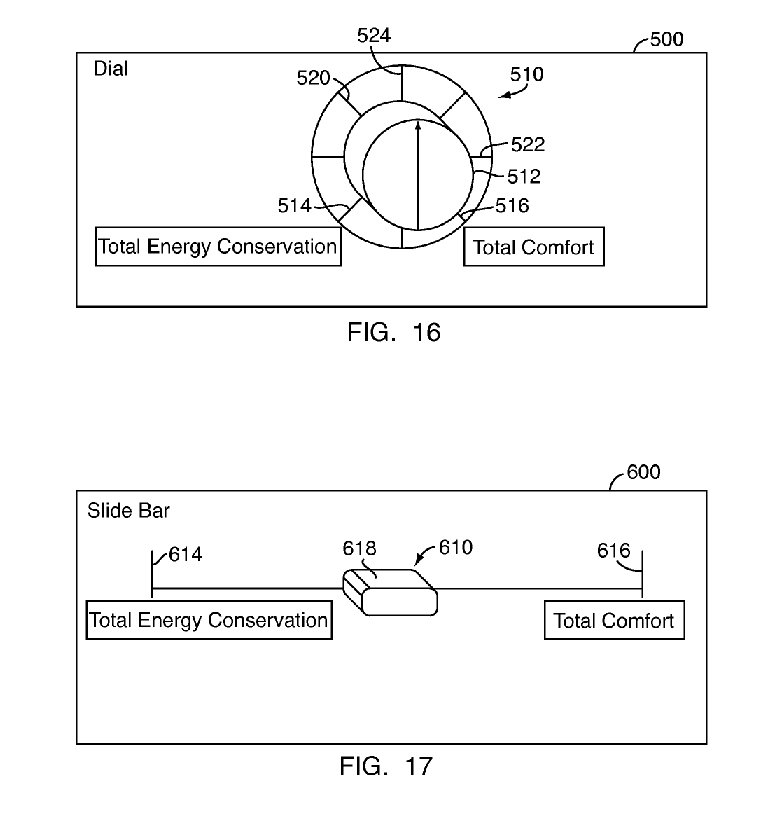

Referring to FIG. 16, the dial system 500 in accordance with an embodiment of the invention is shown. The dial system 500 includes a movable member 510, such as a dial 512. The movable member 510 has a range of motion spanning from a first extreme 514 to a second extreme 516.

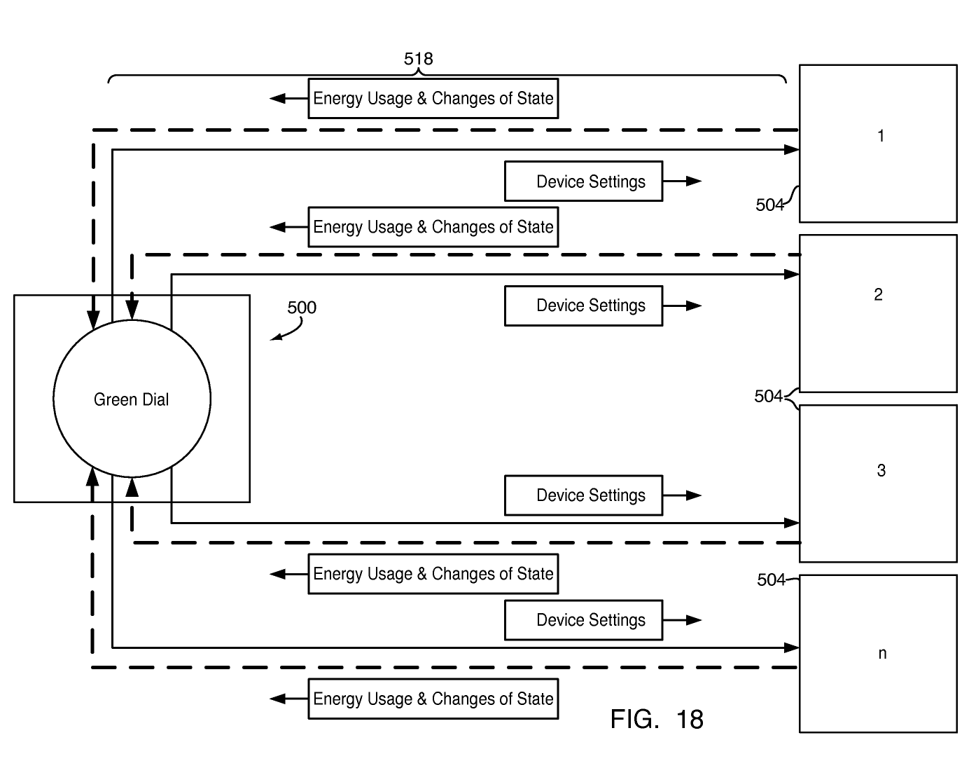

Referring to FIGS. 18 and 19, the dial system 500 is in communication with a controller 518, such at the gateway controller described above, to provide a system and method through which the user may adjust operating settings of the electrical devices 504 (such as lights, plug loads, HVAC and the like) in a substantially simultaneous manner by moving the movable member 510, shown in FIG. 16.

Referring back to FIG. 16, the first extreme 514 may correspond to total energy conservation and the second extreme 516 may correspond to total comfort. In some embodiments, total energy conservation may represent disabling of all lights, plug loads and the like, as well as setting HVAC system temperature set points to levels which do not require either air conditioning or heat to be enabled. Conversely, total comfort may represent enabling lights and plug loads at 100 percent capacity, and setting the air conditioning or heating to run constantly so as to maintain a specific temperature. Preferably, the first extreme 514 and the second extreme 516 are customizable, such that the levels of power consumption at total energy conservation and/or total comfort are customizable, depending upon the application of the dial system 500. For example, total energy conservation may be set to correspond to some minimum level of power sufficient to maintain emergency lighting and to maintain heating at a level sufficient to prevent pipes from freezing in the winter.

Although the dial system 500 is shown in FIG. 16 as including a movable member 510 that is a dial 512, referring to FIG. 17, wherein like numerals represent like elements, the dial system 600 may instead include a movable member 610 that is a slide bar 618. Additionally, although both the dial systems 500 and 600 are shown as physical elements, it should be understood by those skilled in the art that the dial system 500 and 600 may instead be virtual systems displayed on a computer screen or the like.

Referring back to FIG. 16, the dial system 500 allows the user to adjust the balance between energy conservation and user comfort level, through movement of a single input, movable member 510 since the criteria to achieve total energy conservation and the criteria to achieve total comfort are typically on opposite ends of a spectrum. For example, while a cold, dark building conserves a lot of energy in the winter, occupants of the building will most likely be relatively uncomfortable. Thus, the dial system 500 provides a facility manager or other user the ability to readily make subtle adjustments to a building environment, such as an office environment, to achieve a desired balance between energy conservation and occupant comfort. In particular, by turning the dial 510 toward the first extreme 514, the dial system 500 signals the controller 518, shown in FIG. 19, of the energy management system 100, shown in FIG. 19, to adjust the electrical devices 504, shown in FIG. 19, (such as lights, plug loads and HVAC systems) so as to increase energy conservation and decrease comfort level. By turning the dial 510 toward the second extreme 516, the dial system 500 signals the controller 518, shown in FIG. 19, to adjust the electrical devices 504, shown in FIG. 19, so as to increase comfort level and decrease energy conservation.

Referring to FIG. 19, when the dial system 500 is incorporated into the energy management system 100, initial programming and setup may include benchmarking data to determine maximum and minimum usage points within the energy management system 100. Based on the benchmarking data, the operating settings for the electrical devices 504 for total energy conservation and total comfort may be set within the energy management system 100. Additionally, a determination can then be made so as to provide the user with a defined first comfort level that is an estimate of the user's balance between total energy conservation and total comfort. Referring to FIG. 16, the first comfort level may be characterized as a first position 520 on the dial 512 between the first extreme 514 and the second extreme 516.

This first position 520 represents the operating settings for all of the electrical devices 504, shown in FIG. 19, that are set and controlled by the energy management system 100, shown in FIG. 19, to define the building environment that the user believes will be appropriate based on energy goals and employee comfort. When the first comfort level has been set within the energy management system 100, shown in FIG. 19, the controller 518, shown in FIG. 19, (such as the gateway controller previously described herein) may obtain information about how much energy the entirety of the system is consuming.

The dial system 500 allows the facility manager or other user to adjust balance between energy conservation and user comfort by moving the movable member 510 to a second position 522, thereby setting a second comfort level. This second position 522 may be closer to either the first extreme 514, representing total energy conservation, or the second extreme 516, representing total comfort. Once the adjustment has been made, the controller 518, show in FIG. 19, associated with the energy management system 100, shown in FIG. 19, controls the operating settings of the electrical devices 504, shown in FIG. 19, so as to maintain the second comfort level, until the movable member 510 is moved back to the initial first position 520 or a new third position 524.

Additionally, since the movable member 510 has a relatively large range of motion, the dial system 510 allows changes to the operating settings of the electrical devices 504, shown in FIG. 19, to be subtle or extreme in response to small or large changes in position of the movable member 510, respectively. This provides a great deal of flexibility to the user or facilities manager, allowing the user or facilities manager to find a first position 520 between the first extreme 514 and the second extreme 516 that not only appeals to the customer's energy goals, but also satisfies employee comfort.

The dial system 500 may also offer the capability for the user to define multiple comfort levels within the energy management system 100, shown in FIG. 19, with these comfort levels being recalled or restored at will. For example, different comfort levels may be stored in the energy management system 100 for spring, summer, fall and winter, and the customer may use the dial system to recall such comfort levels, when the time is appropriate.

Referring to FIG. 19, the energy management system 100 may also employ input from the dial system 500 in association with certain other features, for maintaining and overseeing comfort levels. These features can be characterized as load balancing, user testing, and pre-cooling.

With respect to load balancing, after the first comfort level has been determined and the controller 518 obtains the energy consumption data for that first comfort level, the load balancing feature can automatically flex the energy management system's energy usage, as energy consumption of the different electrical devices 504 changes, so as to maintain a substantially constant energy usage level. For example, a present day temperature may be higher than a temperature on the day that the first comfort level was set. In such event, the HVAC system may be consuming substantially more energy running air conditioning. To account for such increase in energy usage, the controller 518 may drop lighting levels in some non-critical areas of the building, so as to reduce some energy consumption and bring the total energy usage back to substantially the same level determined by the first comfort level. If the changes made by the controller 518 do not drop the energy consumption a sufficient amount, to account for the increase in HVAC energy consumption, then the controller 518 may disable non-critical plug loads or change the HVAC system's temperature set points in an attempt to achieve the target energy consumption level for the first comfort level.

The load balancing feature may advantageously be applied to whatever comfort level is actively being used. For example, if the current comfort level is different than the first comfort level due to a manual adjustment of the movable member 510, shown in FIG. 16, by the user, the energy consumption level of that new comfort level, e.g. the second or third comfort level, can be marked as the target energy consumption level for load balancing.

The energy management system 100 of the present invention may also include user testing in association with the dial system 500. When executing user testing, the controller 518 may attempt to move the first comfort level toward total energy conservation. The user testing feature may be scheduled to execute as often as desired by the user. For example, user testing can be set up to execute on a daily, weekly or monthly basis.

Each time user testing is executed, the controller 518 may do one or more of the following: lower the lighting levels, lower/raise the HVAC temperature set points, and/or turn off plug loads. If attempted changes do not satisfy the comfort desired by occupants, any manual changes to the environment by means of wall switches, the dial system 500, thermostats or the like may be recorded by the controller 518 and used as feedback to the test. If manual changes to the system are not detected, the user test is deemed successful by the controller 518 and a new comfort level, which is still acceptable to the occupants but is consuming less energy, is set.

The controller 518 may retain the feedback information for use in future executions of the user testing feature. During subsequent user testing, the tests executed by the controller 518 may include functions that attempt to implement the same adjustment or attempt to implement different adjustments. For example, the decision on which test the controller 518 executes may be dependent upon the number of times an adjustment was executed and rejected.

User testing may advantageously span the entirety of the energy management system 100 or, alternatively, may be relegated to a particular zone (i.e. a particular set of lights, plug loads, HVAC systems or the like) or to a set of zones within the energy management system 100.

By executing the user testing feature, the controller 518 may systematically and automatically attempt to optimize the current comfort level. Thus, the user testing feature beneficially reduces energy consumption within the building or a portion of the building, with relatively little awareness of the building's occupants.

Referring to FIG. 19, a further feature of the energy management system 100 implementing the dial system 500 in accordance with certain concepts of the invention includes the pre-cooling feature. To execute pre-cooling, the energy management system 100 receives weather information and forecasts at the controller 518, through WAN 526 or LAN 528. Using this weather information, the controller 518 determines when pre-cooling of the building environment should occur. In particular, the controller 518 determines whether energy is likely to be conserved by cooling the building environment during the night prior to a forecasted warm day and then disabling cooling or otherwise lightly maintaining cooling throughout the warm day as opposed to simply cooling during the warm day. If controller 518 determines that energy is likely to be conserved, the controller 518 executes pre-cooling. Thus, the controller 518 is able to maintain the current comfort level set by the dial system 500 throughout the day, without an increased level of energy consumption by the HVAC system to maintain the air conditioning level necessary to keep the building or other environmental space cool.

The dial system 500 of the present invention advantageously allows the user to balance energy conservation with user comfort using a single input. Additionally, the dial system advantageously provides for discovery and benchmarking of comfort level settings within the energy management system 100. In particular, the dial system 500 may be used for determine minimum/maximum acceptable energy consumption levels and comfort levels for lighting, plug loads, HVAC and the total energy consumption level of the energy management system 100. Additionally, the dial system 500 may beneficially be implemented with real time load balancing, where energy goals are maintained, while automatically maintaining user comfort levels. Further, the dial system 500 may advantageously be implemented with automatic pre-cooling. Still further, the dial system provides a feedback mechanism for user testing to facilitate adjustment of the operating settings of the electrical devices 504 so as to improve energy efficiency.

Referring to FIG. 20, in another embodiment of the present invention, the dial system 500, shown in FIG. 19, may be included with energy management system 100 having an advisor system 530, which may be in the form of a stand-alone or web-based application. The advisor system 530 inputs a variety of information with regard to the building environment being optimized, including fixed building parameters 532, variable building parameters 534 and building usage conditions 536. In some embodiments, the advisor system 530 may also use the position of the movable member 510 as an input. The advisor system 530 may be executed multiple times, as will be discussed in detail below, with the movable member 510 of the dial system 500, shown in FIG. 16, at different positions to adjust the simulations run by the advisor system 530 to achieve relatively more comfort or relatively more energy conservation. Using these various inputs, the advisor system 530 is able to output recommendations 538 for reducing or minimizing energy consumption.

The fixed building parameters 532, variable building parameters 534 and building usage conditions 536 may be input manually or may advantageously be provided in one or more databases. The fixed building parameters 532 are properties of the building that remain constant and may include building orientation, number of windows, window placement, floor space, number of floors, ceiling height, ballast, fixture types and the like. In some embodiments, the fixed building parameters 532 may include the building's electrical and HVAC layouts. These layouts may be provided to the advisor system 530 as computer-aided-design (CAD) drawings, e.g. auto-CAD or the like, schematic layouts, as well as execution with standard CAFM (Computer-Aided Facility Management) tools and software applications.

The variable building parameters 534 are properties of the building that may change and may include quantity/location of occupancy sensors, quantity/location of lighting fixtures and dampers, light levels, plug load states, HVAC system settings and modes and the like.

The building usage conditions 536 provide usage information about the building and may include a database having historical information about the particular building, including information regarding energy usage, light levels, occupancy information, HVAC system settings, local weather forecasts/history and device logs. Advantageously, a substantial amount of information about these parameters may be supplied to advisor system 530 directly from the controller 518, shown in FIG. 19. For example, historical data from the controller 518, shown in FIG. 19, may be input to evaluate building usage for determining what needs to be adjusted to optimize the building. For lighting, the advisor system 530 may input switch usage data, actual lighting levels, motion sensor data, daylight sensor data, and energy usage. Similarly, for HVAC systems, the advisor system 530 may use user input from a thermostat, damper status, weather information, motion data and energy usage. Preferably, the data is time-stamped.

The advisor system 530 may be characterized as a tool that uses data, parameters and a simulation tool to optimize the comfort and energy efficiency of the building environment. For example, using the fixed building parameters 532, variable building parameters 534 and building usage conditions 536, the advisor system 530 provides recommendations 538 based on simulations executed using the building and environmental data. The user may define rules or goals of the simulations, for example, by defining which building parameters are variable, which are fixed, and which are based on usage conditions. The rules may also include limitations on how far light fixtures can be moved, a list of light fixtures that may be used within a particular area or the like. HVAC system rules may include damper positions and temperature ranges. Additionally, a CAD system may be utilized for floor plan layouts, and also to position items, rules and parameters for the simulation.

The simulations run by the advisor system 530 includes a two-part process for optimization. In the first part the advisor system 530 designs the space within the building environment, for example, to recommend the most energy efficient layout of the space. Then, in the second part, the advisor system 530 optimizes the designed space designed in the first part. The simulations run by the advisor system 530 may use genetic algorithms referred to as critters. These genetic algorithms each include the fixed building parameters 532 as well as a different set of values for various variable building parameters 534.

The genetic algorithms are then fed the building usage conditions 536, such as weather and building occupancy data, each of which may vary with time. For example, weather may change on a daily, weekly, monthly or yearly basis and, therefore, the weather data provided to the simulation is preferably over a relatively large period of time. Some genetic algorithms may not execute particularly well based upon the supplied information, while other genetic algorithms will execute well. That is, some genetic algorithms may result in too much energy consumption and/or an extremely uncomfortable building environment, while other genetic algorithms may perform well in terms of energy conservation and workplace comfort. The simulation may combine high performing genetic algorithms with other high performing genetic algorithms to try to develop genetic algorithms that perform even better. Simulations and the evolution of the genetic algorithms preferably continues, until further building optimizations can no longer be obtained. Preferably, the user will be able to visually see the simulation as the simulation progresses.

In operation, the advisor system 530 will execute the first part of the optimization process using the building's floor plan, which may include the fixed building parameters 532, position of lights, type of light fixtures, type of light bulbs used and the like. The plan may also include dampers, shades, position of the building, and how the space may be used for the variable building parameters 534. The advisor system 530 then executes through several simulations, so as to arrive at an optimized plan for the space within the building environment. The advisor system 530 may include suggestions as to different light fixtures to use, positions of fixtures and dampers, and various variable parameters 534 associated with the setup of the space within the building environment.

Then, in the second part of the process, the advisor system 530 uses data for the building usage conditions 536, which may be collected from the controller 518 or provided in a historical database as discussed above, along with the floor plan that includes positions of lights, types of light fixtures and light bulbs used, dampers, shades and the position of the building to execute through several simulations, so as to arrive at an optimized recommendation 538 for reducing or minimizing energy consumption based on the desired comfort level. The advisor system 530 may adjust the various parameters in the simulation to arrive at the optimal recommendation 538.

Upon completion of the simulation, the advisor system 530 outputs the recommendations 538 for the user to follow for purposes of optimizing their building. The advisor system 530 may suggest various light fixtures to use and what power settings to change in the energy management system 100, shown in FIG. 19. The advisor system 530 may also output a file that can be uploaded to the controller 518, shown in FIG. 19, so as to optimize the energy management system 100 automatically. For example, the advisor may provide recommendations for facilitating utilization of electric devices 504, shown in FIG. 19, such as lights, plug loads and HVAC systems, or better utilization, organization and/or location of physical components within the building environment, such as light fixture location/quantity, VAV boxes or location/quantity of occupancy sensors. For example, after execution, the advisor system 530 may recommend that by adding one or more occupancy sensors in a particular area, energy consumption can decrease by a calculated percentage. The recommendations 538 may be provided to the user in the form of a model, a report and/or a graphical representation of a recommended building layout.

It will be apparent to those skilled in the pertinent arts that other embodiments of the methods and systems in accordance with the invention may be designed without departing from the spirit and scope of the above description and accompanying drawings. That is, the principles of the methods and systems in accordance with the inventive concepts described herein shall not be construed as the invention to the specific embodiments described herein. Accordingly, it will be apparent to those skilled in the art that modifications and other variations of the above-described illustrious embodiments of the invention may be effected without departing from the spirit and scope of the novel concepts of the invention.

What is claimed is:

1. A system for balancing user comfort with energy conservation, the system comprising:
an energy management system including a plurality of electrical devices and a controller in communication with the plurality of electrical devices to control operating settings of each electrical device of the plurality of electrical devices; and
a dial system in communication with the energy management system, the dial system including a movable member having a range of movement between a first extreme and a second extreme;
wherein movement of the movable member between the first extreme and the second extreme commands the controller to change the operating settings of each device of the plurality of electrical devices.

2. The system according to claim 1, wherein the plurality of electrical devices includes at least one light.

3. The system according to claim 1, wherein the plurality of electrical devices includes at least one plug load.

4. The system according to claim 1, wherein the plurality of electrical devices includes at least one HVAC system.

5. The system according to claim 4, wherein the operating settings include a temperature set point.

6. The system according to claim 1, wherein the moveable member is a virtual member on a computer screen.

7. The system according to claim 1, wherein the first extreme is total energy conservation and the second extreme is total comfort.

8. The system according to claim 7, wherein the controller changes the operating settings of the plurality of electrical devices to reduce energy consumption when the movable member is moved toward total energy conservation.

9. The system according to claim 7, wherein the controller changes the operating settings of the plurality of electrical devices to improve user comfort when the moveable member is moved toward total comfort.

10. A method for balancing user comfort with energy conservation in an energy management system having a plurality of electrical devices, the method comprising:
positioning a movable member at a first position between a first extreme and a second extreme; and
controlling operating settings of the plurality of electrical devices in accordance with the first position of the movable member.

11. The method according to claim 10, additionally comprising:
moving the movable member to a second position between the first extreme and the second extreme; and
changing the operating settings of the plurality of electrical devices in accordance with the second position.

12. The method according to claim 10, wherein the first extreme is total energy conservation and the second extreme is total comfort.

13. The method according to claim 12, wherein the operating settings of the plurality of electrical devices are changed to reduce energy consumption when the movable member is moved toward the total energy conservation extreme.

14. The method according to claim 12, wherein the operating settings of the plurality of electrical devices are changed to improve user comfort when the moveable member is moved toward the total comfort extreme.

15. The method according to claim 10, additionally comprising changing the operating settings of at least one electrical device of the plurality of electrical devices in response to a changed operating setting of another electrical device of the plurality of electrical devices, while the movable member remains positioned at the first position, to maintain a current level of energy consumption.

16. A method for optimizing energy conservation in a building having an energy management system with a plurality of electrical devices, the method comprising:
inputting one or more fixed building parameters;
defining one or more variable building parameters;
inputting one or more sets of building usage conditions predicting building usage; and
minimizing energy consumption by the energy management system in accordance with the fixed building parameters and the predicted building usage by varying the variable building parameters.

17. The method according to claim 16, wherein the one or more sets of building usage conditions includes weather data.

18. The method according to claim 16, wherein the one or more sets of building usage conditions includes occupant activity data.

19. The method according to claim 16, wherein the one or more fixed building parameters includes building structure information.

20. The method according to claim 16, wherein varying the one or more variable building parameters includes changing the location of one or more components of the energy management system.
